(19) United States
(12) Patent Application Publication
(10) Pub. No.: US 2021/0097211 A1
(43) Pub. Date: Apr. 1, 2021

(54) TECHNIQUES TO CUSTOM DESIGN PRODUCTS

(71) Applicant: Covestro LLC, Pittsburgh, PA (US)

(72) Inventors: Angela M. Beck, New Orleans, LA (US); David D. Steppan, Gibsonia, PA (US); John P. Forsythe, Allison Park, PA (US); James R. Charron, Pittsburgh, PA (US); Edward P. Squiller, Bridgeville, PA (US); Kurt E. Best, Wexford, PA (US); Andrew Stadler, Allison Park, PA (US); Currie Crookston, Pittsburgh, PA (US)

(21) Appl. No.: 17/045,600

(22) PCT Filed: Apr. 8, 2019
(86) PCT No.: PCT/US2019/026294

§ 371 Date: Oct. 6, 2020

Related U.S. Application Data
(60) Provisional application No. 62/748,762, filed on Oct. 22, 2018.
(60) Provisional application No. 62/654,641, filed on Apr. 9, 2018.

(51) Int. Cl. G06F 30/10; G06Q 30/06; G06Q 10/08; G06Q 30/08; G06N 7/00; G06F 3/14

(52) U.S. Cl. CPC G06F 30/10; G06Q 30/0621; G06Q 10/0875; G06Q 30/0633; G06F 2111/02; G06Q 30/0605; G06Q 30/0643; G06N 7/005; G06F 3/14; G06Q 30/08

(57) ABSTRACT

Disclosed are methods of producing a graphical depiction of a predicted value of a property of a material. In accordance with the method, a processing unit generates a plot defining a geometric shape and comprising a plurality of points arranged in a matrix, each of the points defining a value for at least two variables and a predicted value of a property of the material. A visual representation of the predicted value of the property of the material for at least some of the plurality of points in a range of indicia is displayed on an output device. The range of indicia represents a range of predicted values of the property. A pointer on the visual representation is displayed on the output device.

### PRIORITY TO OTHER APPLICATIONS

This application claims priority to U.S. Provisional Patent Application No. 62/748,762, filed Oct. 22, 2018 and also to U.S. Provisional Patent Application No. 62/654,641, filed Apr. 9, 2018.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### TECHNICAL FIELD

This disclosure is generally related to a client-server based visualization mapping techniques. More particularly, this disclosure is related to a web based graphical user interface to enable users to custom-design product configurations tailored to their unique application needs.

### BACKGROUND

Client-server based graphical user interfaces can be configured to enable users to custom-design product configurations tailored to their unique application needs. A plot may be employed to define a design space for a variety of products to reduce development time and provide self-service formulation assistance.

A ternary plot, ternary graph, triangle plot, simplex plot, or Gibbs triangle is a barycentric plot on three variables which sum to a constant. It graphically depicts the ratios of the three variables as positions in an equilateral triangle. It is used in physical chemistry, petrology, mineralogy, metallurgy, and other physical sciences to show the compositions of systems composed of three species.

In a ternary plot, the proportions of the three variables a, b, and c must sum to some constant, K. Usually, this constant is represented as 1.0 or 100%. Because a+b+c=K for all substances being graphed, any one variable is not independent of the others, so only two variables must be known to find a sample's point on the graph: for instance, c must be equal to K−a−b. Because the three proportions cannot vary independently—there are only two degrees of freedom—it is possible to graph the combinations of all three variables in only two dimensions. Ternary plots can be used for materials with n>3 components. The ternary plot then represents the three components with each of the other n-3 components held at a fixed proportion.

Design of experiments techniques may be employed to design any task that aims to describe or explain the variation of information under conditions that are hypothesized to reflect the variation. In one form, an experiment aims at predicting the outcome by introducing a change of preconditions, which is reflected in a variable called the predictor (independent). The change in the predictor is generally hypothesized to result in a change in the second variable, hence called the outcome (dependent) variable. Experimental design involves not only the selection of suitable predictors and outcomes, but planning the delivery of the experiment under statistically optimal conditions, given the constraints of available resources.

In experimental design, the predictor may be chosen to reduce the risk of measurement error. The experimental design should achieve appropriate levels of statistical power and sensitivity.

### SUMMARY

In one aspect, the present disclosure provides a method of producing a graphical depiction of a predicted value of a property of a material. The method comprises generating, by a processing unit, a plot defining a geometric shape and comprising a plurality of points arranged in a matrix, each of the points defining a value for at least two variables and a predicted value of a property of the material; generating, by a processing unit, an illustration defining a geometric shape and comprising a dynamically changing predicted characteristic, wherein the dynamically changing characteristic comprises a predicted value of a property of the material; displaying, on an output device, a visual representation of the predicted value of the property of the material for at least some of the plurality of points in a range of indicia, wherein the range of indicia represents a range of predicted values of the property; displaying, on the output device, a point on the visual representation, wherein the visual representation comprises a spider-plot illustrating the values associated with the point with regard to the axis of the geometric shape; and wherein dynamically moving the point on the visual representation dynamically changes the predicted characteristic depicted on the illustration.

### FIGURES

FIG. 1 is a graphical depiction of a ternary plot axis A according to one aspect of this disclosure.

FIG. 2 is a graphical depiction of a ternary plot axis B according to one aspect of this disclosure.

FIG. 3 is a graphical depiction of a ternary plot axis C according to one aspect of this disclosure.

FIG. 4 is a graphical depiction of a final ternary plot according to one aspect of this disclosure.

FIG. 5 is a graphical depiction of a ternary map page according to one aspect of this disclosure.

FIG. 6 is a graphical depiction of a ternary map page according to one aspect of this disclosure.

FIG. 7 is a graphical depiction of an optimization property of a ternary plot according to one aspect of this disclosure.

FIG. 8 is an example display of a stored selection table showing stored formulations according to one aspect of this disclosure.

FIG. 9 is an example display of a stored selection table showing suggested formulations according to one aspect of this disclosure.

FIG. 10 is an example display of settings and property descriptions according to one aspect of this disclosure.

FIG. 11 is a graphical depiction of a ternary map page according to one aspect of this disclosure.

FIG. 12 is a graphical depiction of a ternary map page according to one aspect of this disclosure.

FIG. 13 is a graphical depiction of an optimization property of a ternary plot according to one aspect of this disclosure.

FIG. 14 is an example display of a stored selection table showing suggested formulations according to one aspect of this disclosure.

FIG. 15 is an example display of a stored selection table showing stored formulations according to one aspect of this disclosure.

FIG. 16 is an example display of settings and property descriptions according to one aspect of this disclosure.

FIG. 17 illustrates an example computing environment wherein one or more of the provisions set forth herein may be implemented.

FIG. 18 is a logic flow diagram of a logic configuration or process of a method of producing a graphical depiction of a predicted value of a property of a material according to one aspect of this disclosure.

FIG. 19 is a logic flow diagram of a logic configuration or process of a method of producing a graphical depiction of a predicted value of a property of a material according to one aspect of this disclosure.

FIG. 20 is a logic flow diagram of a logic configuration or process 2000 of a method of producing a graphical depiction of a predicted value of a property of a material according to one aspect of this disclosure.

FIG. 21 shows a basic block diagram of a user or customer interfacing with the digital formulation service, which may be manifested in a computerized module.

FIG. 22 shows one model for how the digital formulation service may complete a custom coating order, according to some aspects.

FIG. 23 shows a second model in a variation of how the digital formulation service may complete a custom coating order, according to some aspects.

FIG. 24 shows another model in another variation of how the digital formulation service may complete a custom coating order, according to some aspects.

FIG. 25 shows how after generating a recommended material configuration that satisfies the user specified constraint(s), the digital formulation service module may be configured to interface with one or more purchasing/trade platforms that supply the ingredients needed to generate the recommended formulation, according to some aspects.

FIG. 26 shows a block diagram for the purchase mechanisms that can be extended to include convenient and more streamlined features that can automatically connect to appropriate suppliers.

### DESCRIPTION

In one aspect, the present disclosure is directed to a client-server based visualization mapping techniques that employs graphical user interfaces configured to enable users to custom-design product configurations tailored to their unique application needs. A plot may be employed to define a design space for a variety of products to reduce development time and provide self-service formulation assistance. The plot may be incorporated in a graphical user interface on a client that runs a web server in a cloud based system.

Before describing various aspects of client-server based visualization mapping techniques, the disclosure turns briefly to a description of the design of experiment technique that may be used to build a database of data used to generate ternary maps to enable users to custom-design various products by manipulating the ratios of the three variables as positions in an equilateral triangle and providing a graphical depiction of the results on a screen or display of a computer, tablet, smartphone, or other web based client appliance. In one aspect, a statistical software application known under the trade name of Design-Expert from Stat-Ease Inc. may be employed to create and analyze a design of experiments to generate model equations that drive the ternary maps of a ternary map interface according to the present disclosure. Other statistical software applications for generating and analyzing a design of experiments include, for example, statistical software applications known under the trade name ECHIP, JMP, and Minitab.

It will be appreciated that there are many considerations when creating, executing, and analyzing a design of experiments. The methodology used to create the ternary map described herein provide an example of one way in which experimental data can be used to drive an interactive, graphical interface. In one aspect, computer generated data may be employed to drive the ternary map interface in accordance with the present disclosure. In other aspects, real measurement data may be employed to drive the ternary map interface. In yet another aspect, real measurement data may be employed to drive the ternary map interface and computer generated data may be employed to fill in any gaps in the real measurement data.

In one formulation generation example, a polyurethane coating, comprising an A and B side, is analyzed. The system is evaluated using a two-mixture design, with one mixture (Mixture 1) based on the relative amounts of three components and the other mixture (Mixture 2) based on the relative amounts of two components. A design of experiments formulation data set can be created using the DesignExpert software application. Upon specifying the design space and generating a set of formulations, the coatings are prepared and cured on appropriate test substrates. Each property is then measured and recorded in a Design-Expert data table. The formulation data set can be stored in a database.

Once the data has been accumulated, it can be analyzed to develop model equations. There are a variety of approaches to selecting the terms for the final model, for example, a threshold p-value can be chosen, an information criterion statistic can be minimized (such as the Corrected Aikake's Information Criterion or the Bayesian Information Criterion), or another statistic can be optimized, such as R-square adjusted or Mallow's Cp. Additionally, a validation set of points may be withheld from the model building process, with the final model chosen as the best fit (again, a variety of criteria can be used to determine best fit) of the validation set. These approaches can be performed in a stepwise approach with Forward selection, that is starting with a model with no terms and stepwise adding one at a time, Backward selection, starting with the full model and reducing terms one by one, or one that mixes Forward and Backward selection. The addition and reduction of terms is stopped when the chosen criteria is met. Commercially available statistical software packages support these, as well as other, approaches.

In one example, computer generated data may be employed as input for the responses. For each response, the significant model terms may be identified by starting with a full quadratic model and performing a backwards stepwise elimination with minimization of the Bayesian Information Criterion (BIC) as the stopping rule. Standard least squares regression can then be used to determine the coefficients of the significant model terms for the final model equation. The following process demonstrates at a high level the use of this approach for the first response, “Property 1,” in the Design-Expert software application.

A “Property 1” response is selected under the analysis tree. An initial model is chosen and a response fit summary is selected. Model reduction may be done manually or using an automated method. If an auto-select model is selected, model selection criteria are entered into the automatic model selection window. Upon completion of the above process, the selected design of experiments model is accepted and the analysis of variance (ANOVA), a statistical method in which the variation in a set of observations is divided into distinct components, is selected. The application (such as the Design-Expert application) then performs an R-Squared analysis and provides the user an opportunity to review the R-Squared analysis, adjust the R-Squared, and predetermine the R-Squared values to ensure the values are within the range desired for the response being evaluated. The application (such as the Design-Expert application) calculates a variety of statistics to assess the fit of the selected model to the data, including, for example, R-Squared, Adjusted R-Squared, Predicted R-Squared, standard deviation, and PRESS (Predicted Residual Error Sum of Squares). In addition, the application provides a Diagnostics section, where the validity of the ANOVA assumptions can be evaluated, the data can be examined for outliers from the model and other such important model building concerns can be gauged. Finally, the model graphical depictions may be selected and the final equation in terms of real components may be evaluated. The final equation may be employed to populate a data table for the ternary map interface for all properties.

A model for generating predictive values of properties of materials includes, without limitation, design of experiments, regression analysis of a data set, an equation, machine learning, or artificial intelligence, and/or any combination thereof. In one aspect, the model used to generate the predicted values of the properties of a material for a ternary plot is generated from a design of experiment technique. In other aspects, models for generating predictive values of properties include a statistical analysis of unstructured data, such as that generated by a historian of a distributive control system of a chemical manufacturing plant. For example, models of the dependence of polydimethylsiloxane (PDMS) modified polyolefin (PMPO) viscosity on solids content and other variables that are reasonably accurate within small ranges may be generated from such unstructured data. In other aspects, artificial intelligence methods may be employed to mine a large number of experimental systems in a company's lab notebook system and research papers. In other aspects, an analytical model may be generated based on scientific first principles. For example, a graphical user interface (GUI) may be configured to display pressure at a given volume and temperature of mixtures of multiple gases, predicted by a non-ideal gas law, for example.

Various material properties are tabulated in Table 1 below. As described herein, graphical depictions of ternary maps, among others, can be used to design products having a particular material property, short or long, as described in Table 1. Properties include, without limitation, properties often associated with coatings, such as Soft Feel, 5 Finger Scratch Resistance, Diethyltoluamide (DEET) Solvent Resistance, Coefficient of Friction, and properties often associated with polyurethane foams, such as flexible polyurethane foams, such as Density, Indentation Force Deflection 25%, Indentation Force Deflection 40%, Indentation Force Deflection 65%, Tensile Strength, Elongation, Tear Strength, Maximum Temperature, Compression Strength 90%, Humid Age Compression Set 75%, Fatigue Loss, among others, for example.

TABLE 1
Material Properties

| Interface | Property (short) | Property (Iona) | Units | Min | Max |
|---|---|---|---|---|---|
| Ternary Map | Soft Feel | Soft Feel | N/A | 0.25 | 4.4 |
| | 5 Finger Scratch | 5 Finger Scratch | N/A | 0.73 | 6 |
| | Resistance | Resistance | | | |
| | Diethyltoluamide | Diethyltoluamide | N/A | 1.8 | 4.9 |
| | (DEET) Solvent | (DEET) Solvent | | | |
| | Resistance | Resistance | | | |
| | Coefficient of | Coefficient of | N/A | 2 | 5.5 |
| | Friction | Friction | | | |

Generally, in one aspect, the present disclosure provides a method of producing a graphical depiction of a predicted value of a property of a material. The method includes generating, by a processing unit, a plot defining a geometric shape and comprising a plurality of points arranged in a matrix, each of the points defining a value for at least two variables and a predicted value of a property of the material. The method includes displaying, on an output device, a visual representation of the predicted value of the property of the material for at least some of the plurality of points in a range of indicia, wherein the range of indicia represents a range of predicted values of the property. At least some of the plurality of points in a range of indicia means at least two of the plurality of points up to an including each of the plurality of points in a range of indicia, such as a majority of the plurality of points. The method further includes displaying, on the output device, a pointer on the visual representation. At least one of the at least two variables may be an independent variable. The visual representation may be a heat map, a color heat map, or a contour map. The material may be a foam, a coating, an adhesive, a sealant, an elastomer, a sheet, a film, a binder, or any organic polymer, for example.

In one aspect, the method includes displaying, on the output device, the value of the indicia and property of the material based on a position of a cursor on the visual representation. In one aspect, the method includes dynamically updating the location of the pointer and an element as the pointer is dragged over the visual representation. The element may include a numeric value or a descriptor of the property, for example. The element may include indicia within the range of indicia that represents the predicted value or the descriptor of the property in the visual representation, for example.

In one aspect, the geometric shape defines a closed shape in Euclidian space. The closed shape may define a polygon, for example. The polygon may be a triangle or a four-sided polygon, for example. In the case where the polygon is a triangle, each of the points may define a value for three variables, where each variable represents a value for an amount of a component in a composition, such as the relative amount of components in a composition to each other. The amounts may be expressed as a percentage and a sum of the amounts is 100%, for example. In the case where the polygon is a four-sided polygon, each of the points may define a value for two variables, where each variable is a value for an amount of a component in a composition, a value for a processing condition, or a value representing an amount of two components of the composition relative to each other. The closed shape may define an ellipse or a circle, for example. The closed shape may define either a two-dimensional space or a two-dimensional perspective projection of a three-dimensional shape, for example.

In another aspect, the method includes formulating, by the processing unit, a composition based on the visual representation of the predicted value of the property of the material for at least some of the plurality of points in the range of indicia. The composition may be formulated based on a plurality of properties for at least some of the plurality of points in the range of indicia, for example. The method may also include optimizing, by the processing unit, one or more than one property of the material within one or more than one defined range of indicia. A gridded region that represents one or more than one optimized region based on the one or more than one defined range of indicia may be displayed on the output device, for example.

In one aspect, the method includes updating, by the processing unit, a table with current values of the at least two variables and the predicted value of the property based on the location of the pointer on the visual representation. The method may also include generating, by the processing unit, a set of instructions for producing a product that exhibits the predicted value of the property of the material at one of the plurality of points in the range of indicia.

In one aspect, the method also includes generating, by the processing unit, a plurality of plots each defining a geometric shape and each including a plurality of points arranged in a matrix where each of the points defines a value for at least two variables and a predicted value of the property of the material for each of the plurality of plots. A visual representation of the predicted value of the property of the material for at least some of the plurality of points in a range of indicia may be displayed on the output device. The range of indicia may represent a range of predicted values of the property. A pointer may be displayed on each of the plurality of plots.

In one aspect, the method includes generating, by the processing unit, a plot based on a model. The model may be generated based on design of experiments, regression analysis of a data set, an equation, machine learning, or artificial intelligence, and/or any combination thereof.

In one aspect, the plot defines a triangle including a plurality of points arranged in a matrix where each of the points define a value for three variables and a predicted value of a property of the material. A color heat map representation of the predicted value of the property of the material for at least some of the plurality of points in a range of colors may be displayed on the output device. The range of colors may represent a range of predicted values of the property. A pointer may be displayed on the heat map.

In another aspect, the plot defines a four-sided polygon including a plurality of points arranged in a matrix where each of the points defines a value for at least two variables and a predicted value of the property of the material. A color heat map representation of the predicted value of the property of the material for at least some of the plurality of points in a range of colors may be displayed on the output device. The range of colors may represent a range of predicted values of the property. A pointer may be displayed on the heat map.

### Ternary Map Interface

In one aspect, the present disclosure provides a web based ternary map graphical user interface (GUI) that runs in any HTML5 compliant browser. The web based ternary map GUI may be created using web visualization software. Accordingly, the web based ternary map GUI can be use on modern cell phones, tablets, and personal computers. The interface may be accessed published to the cloud and may be made available to users via a website.

The ternary map GUI is a user-friendly interface that may be made available for self-service 24 hours per day and 7 days per week. All calculations conducted by the ternary map GUI are performed “behind” the face of the engine to protect the data used to build the models and to prevent the user from accidentally causing damage to the functionality of the ternary map GUI, as would be the case with a spreadsheet solution. The ternary map GUI user interface allows users to interact with the data table created by design of experiments techniques through graphical icons and visual indicators such as secondary notation, instead of text-based user interfaces, typed command labels or text navigation.

The ternary map GUI provides a fast, low cost solution to assist users in better understanding available products. The ternary map GUI requires unique username and password access to use. The structure of the ternary map GUI is universal, in that it can be customized to a user's wants and needs. Its dynamic nature allows the modeling of any type of product on the market.

### Reading a Ternary Plot

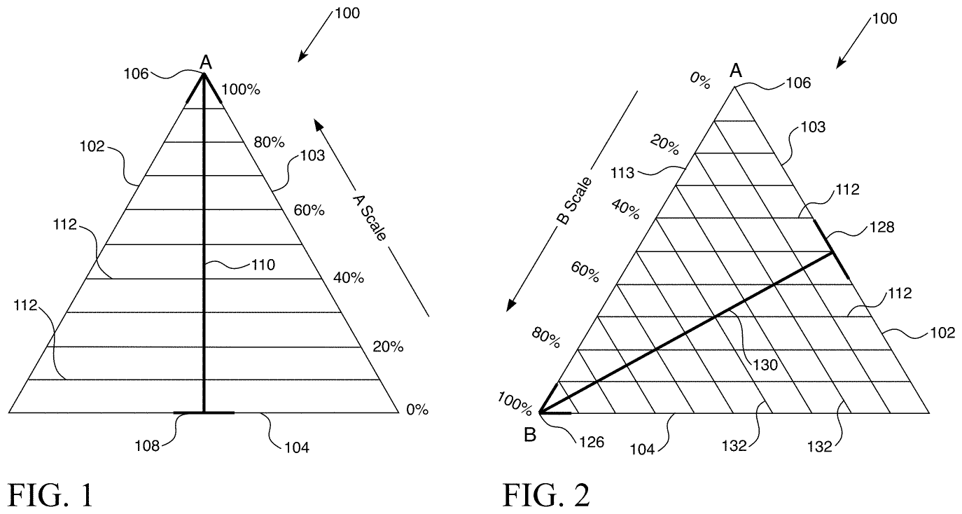

FIGS. 1-3 are graphical depictions of a ternary plot 100 according to one aspect of this disclosure. The ternary map GUI is made up of multiple ternary plots 100 that represent properties of interest. Before delving into the interface, it may be useful to review how ternary plots 100 are read. The ternary plots 100 generated by the ternary map GUI are triangles 102 with each vertex A, B, C corresponding, for example, to a resin that may be included in a designed formulation. For conciseness and clarity of disclosure, the vertices within this section will be referred to as A, B, and C.

To understand the three axes of a ternary plot 100, each axis (A, B, and C) will be evaluated separately. As shown in FIG. 1, vertex A is located at the top 106 of the triangle 102 and its axis runs along the right edge 103 of the triangle 102, indicating the value, such as a percentage, of A and labeled as “A Scale.” The base 108 of the indicator arrow 110, farthest from vertex A, coincides with the bottom edge 104 of the triangle 102 and represents, in this example, an A value of 0%. The value of A is determined by the intersection of lines 112 drawn parallel to the bottom edge 104 and the right edge 103 of the ternary plot 100. The indicator arrow 110 shows the direction of increasing A.

As shown in FIG. 2, vertex B is the lower left corner 126 of the ternary plot 100, with, in this example, a percent scale running along the left edge 113 of the triangle 102. The percent scale is rotated 120 degrees counter clock wise relative to the ternary plot 100 shown in FIG. 1 and labeled “B Scale.” The base 128 of the indicator arrow 130, farthest from vertex B, coincides with the right edge 103 of the triangle 102 and represents, in this case, a B value of 0%. The right edge 103 of the triangle 102 represents a baseline for vertex B with a corresponding percent scale that runs along the left edge 113 of the triangle 102. As with A, the value of B is determined by the intersection of lines 132 drawn parallel to the right edge 103, which is the baseline for vertex B, and the left edge 113 of the triangle 102. The indicator arrow 130 shows the direction of increasing B.

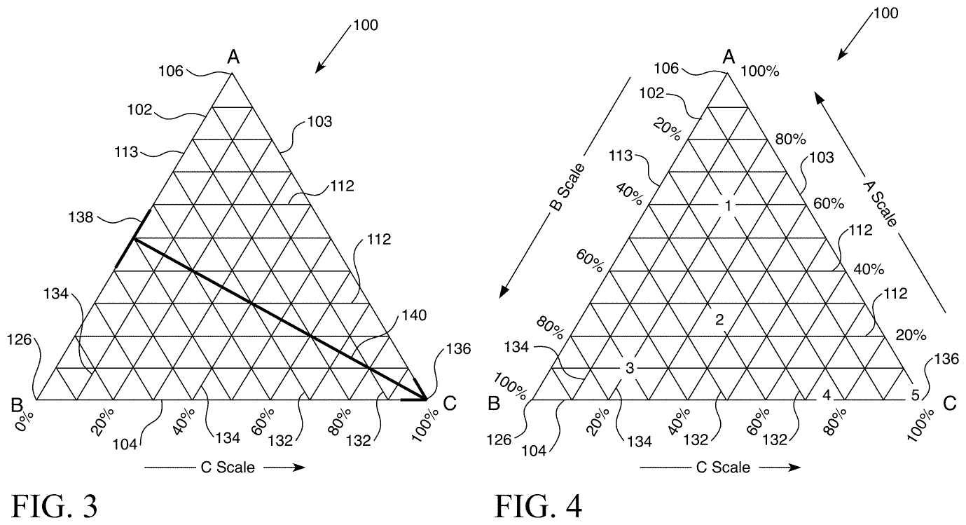

As shown in FIG. 3, vertex C is the lower right vertex 136 of the ternary plot 100, with a percent scale running along the baseline 104 rotated another 120 degrees counter clock wise relative to FIG. 2 and labeled “C Scale.” The left edge 113 of the triangle 102 represents the baseline for vertex C with a corresponding percent scale that runs along the bottom edge 104 of the triangle. The base 138 of the indicator arrow 140, farthest from vertex C, coincides with the left edge 113 of the triangle 102 and represents, in this case, a C value of 0%. As with A and B, C is determined by the intersection of lines 134 drawn parallel to the baseline 138 and the left edge 113 of the triangle 102. The indicator arrow 140 shows the direction of increasing C.

As shown in FIG. 4, combining all three axes and eliminating the indicator arrows, the resultant ternary plot 100 represents a three dimensional space. For illustration purposes, the quantity of the composition for each of the points 1-5 on the ternary plot 100 is shown in Table 2.

TABLE 2
Composition values for each point (1-5) by way of example.

| Point | A | B | C | Total |
|---|---|---|---|---|
| 1 | 60% | 20% | 20% | 100% |
| 2 | 25% | 40% | 35% | 100% |
| 3 | 10% | 70% | 20% | 100% |
| 4 | 0.0% | 25% | 75% | 100% |
| 5 | 0.0% | 0.0% | 100% | 100% |

As noted in Table 1, at any point located on the ternary plot 100, all three coordinates will total 100%. Additional information on ternary plots may be sourced from Reading a Ternary Diagram, Ternary plotting program, Power Point presentation from http://csmres.jmu.edu/geollab/Fichter/SedRx/readternary.html, which is incorporated herein by reference.

### Ternary Map GUI Maps

In one aspect, a ternary map GUI may be accessed by way of a login page that serves as a gateway to accessing the ternary map GUI. Once a user has been granted access to utilize the ternary map GUI, he/she will enter the assigned username and password into the provided entry boxes. Once a user has signed in, the home screen provides a tab or other selectable item that the user may select to open a ternary map GUI. In one aspect, the ternary map GUI allows a user to design products using resins, or other products, based on properties of interest as discussed below.

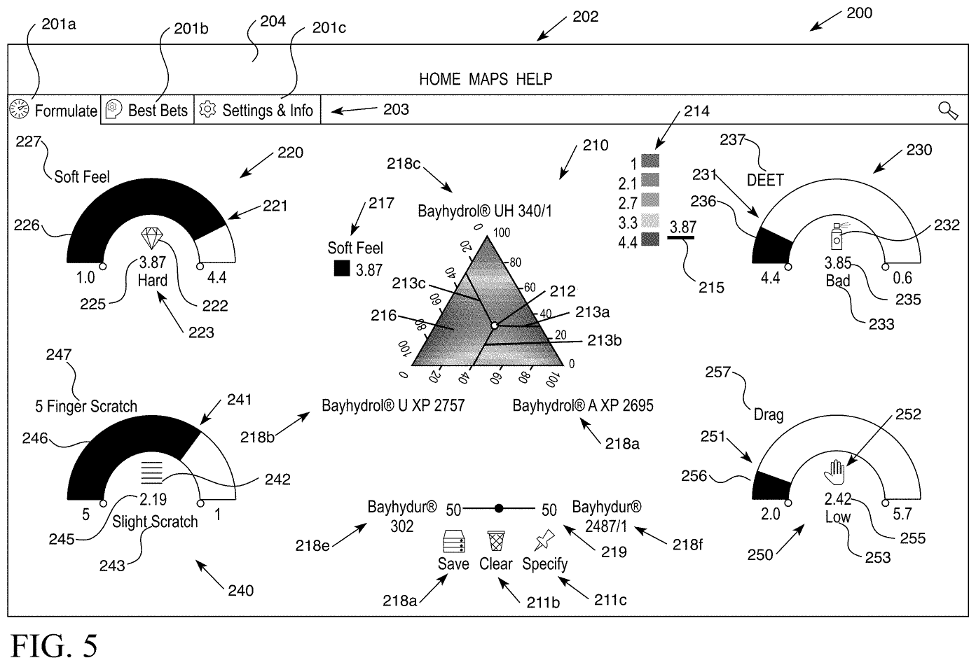

FIG. 5 is a graphical depiction of a ternary map GUI page 200 according to one aspect of this disclosure. The ternary map GUI page 200 includes a title bar 202 and a menu bar 204 that includes section tabs “Home,” “Maps,” and “Help,” for example. Below the menu bar 204, is a sheet tab selection bar 203 having tabs 201a, 201b, and 201c, for example. In this description, the acronym “PUD” refers to polyurethane dispersion and the acronym “ISO” refers to isocyanate. Polyurethane dispersions (PUDs) have recently been incorporated into a variety of products and offer several advantages over conventional technologies such as acrylics and acryl amide copolymers, polyvinyl pyrrolidone, and PVP/VA copolymers. Such advantages include water compatibility, ease of formulating low VOC sprays, water resistance and excellent film forming ability. Polyurethane dispersions (PUDs) and methods of making them may be found for example in Polyurethanes—Coatings, Adhesives and Sealants, Ulrich Meier-Westhues, Vincentz Network GmbH & Co., KG, Hannover, (2007), Ch. 3, the contents of which are incorporated herein by reference.

Polyurethane dispersions useful in the present disclosure contain: (A) at least one diol and/or polyol component (B) at least one di- and/or polyisocyanate component (C) at least one component including at least one hydrophilizing group (D) optionally mono-, di- and/or triamine-functional and/or hydroxylamine-functional compounds, and (E) optionally other isocyanate-reactive compounds.

Suitable diol- and/or polyol components (A) are compounds having at least two hydrogen atoms which are reactive with isocyanates and have an average molecular weight of preferably 62 to 18000 and particularly preferably 62 to 4000 g/mol. Examples of suitable structural components include polyethers, polyesters, polycarbonates, polylactones and polyamides. Preferred polyols (A) preferably have 2 to 4, particularly preferably 2 to 3 hydroxyl groups, and most particularly preferably 2 hydroxyl groups. Mixtures of different such compounds are also possible.

Possible polyester polyols are in particular linear polyester diols or indeed weakly branched polyester polyols, as can be prepared from aliphatic, cycloaliphatic or aromatic di- or polycarboxylic acids, such as succinic, methylsuccinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic, cyclohexane dicarboxylic, maleic, fumaric, malonic or trimellitic acid and acid anhydrides, such as o-phthalic, trimellitic or succinic acid anhydride or mixtures thereof with polyhydric alcohols such as ethanediol, di-, tri-, tetraethylene glycol, 1,2-propanediol, di-, tri-, tetrapropylene glycol, 1,3-propanediol, butanediol-1,4, butanediol-1,3, butanediol-2,3, pentanediol-1,5, hexanediol-1,6, 2,2-dimethyl-1,3-propanediol, 1,4-dihydroxycyclohexane, 1,4-dimethylol cyclohexane, octanediol-1,8, decanediol-1,10, dodecanediol-1,12 or mixtures thereof, optionally with the use of higher-functional polyols, such as trimethylol propane, glycerine or pentaerythritol. Cycloaliphatic and/or aromatic di- and polyhydroxyl compounds are also possible as the polyhydric alcohols for preparing the polyester polyols. Instead of free polycarboxylic acid, it is also possible to use the corresponding polycarboxylic acid anhydrides or corresponding polycarboxylic acid esters of low alcohols or mixtures thereof for preparing the polyesters.

The polyester polyols may be homopolymers or mixed polymers of lactones which are preferably obtained by the addition of lactones or lactone mixtures, such as butyrolactone, ϵ-caprolactone and/or methyl-ϵ-caprolactone, to suitable di- and/or higher-functional starter molecules, such as the low-molecular-weight polyhydric alcohols mentioned above as structural components for polyester polyols. The corresponding polymers of ϵ-caprolactone are preferred.

Polycarbonates having hydroxyl groups are also possible as the polyhydroxyl components (A), e.g. those which can be prepared by reacting diols such as 1,4-butanediol and/or 1,6-hexanediol with diaryl carbonates, such as diphenyl carbonate, dialkyl carbonates, such as dimethyl carbonate, or phosgene. As a result of the at least partial use of polycarbonates having hydroxyl groups, the resistance of the polyurethane dispersion to hydrolysis can be improved.

Suitable polyether polyols are for example the polyaddition products of styrene oxides, ethylene oxide, propylene oxide, tetrahydrofuran, butylene oxide, epichlorohydrin, and mixed addition and grafting products thereof, and the polyether polyols obtained from condensation of polyhydric alcohols or mixtures thereof and from alkoxylation of polyhydric alcohols, amines and amino alcohols. Polyether polyols which are suitable as structural components A) are the homopolymers, mixed polymers and graft polymers of propylene oxide and ethylene oxide which are obtainable by the addition of the said epoxies to low-molecular-weight diols or triols, such as those mentioned above as structural components for polyester polyols, or to higher-functional low-molecular-weight polyols such as pentaerythritol or sugar, or to water.

Other suitable components (A) are low-molecular-weight diols, triols and/or tetraols such as ethanediol, di-, tri-, tetraethylene glycol, 1,2-propanediol, di-, tri-, tetrapropylene glycol, 1,3-propanediol, butanediol-1,4, butanediol-1,3, butanediol-2,3, pentanediol-1,5, hexanediol-1,6, 2,2-dimethyl-1,3-propanediol, 1,4-dihydroxycyclohexane, 1,4-dimethylol cyclohexane, octanediol-1,8, decanediol-1,10, dodecanediol-1,12, neopentyl glycol, 1,4-cyclohexane diol, 1,4-cyclohexane dimethanol, 1,4-, 1,3-, 1,2-dihydroxybenzene or 2,2-bis-(4-hydroxyphenyl)-propane (bisphenol A), TCD-diol, trimethylol propane, glycerine, pentaerythritol, dipenthaerythritol or mixtures thereof, optionally also using further diols or triols which are not mentioned.

Suitable polyols are reaction products of the said polyols, in particular low-molecular-weight polyols, with ethylene and/or propylene oxide.

The low-molecular-weight components (A) preferably have a molecular weight of 62 to 400 g/mol and are preferably used in combination with the polyester polyols, polylactones, polyethers and/or polycarbonates mentioned above.

Preferably, the content of polyol component (A) in the polyurethane according to this disclosure is 20 to 95, particularly preferably 30 to 90, and most particularly preferably 65 to 90 wt. %.

Suitable as component (B) are any organic compounds which have at least two free isocyanate groups in each molecule. Preferably, diisocyanates Y(NCO)2 are used, wherein Y represents a divalent aliphatic hydrocarbon radical having 4 to 12 carbon atoms, a divalent cycloaliphatic hydrocarbon radical having 6 to 15 carbon atoms, a divalent aromatic carbon radical having 6 to 15 carbon atoms or a divalent araliphatic hydrocarbon radical having 7 to 15 carbon atoms. Examples of such diisocyanates which are preferably used are tetramethylene diisocyanate, methylpentamethylene diisocyanate, hexamethylene diisocyanate, dodecamethylene diisocyanate, 1,4-diisocyanato-cyclohexane, 1-isocyanato-3,3,5-trimethyl-5-isocyanatomethyl-cyclohexane (IPDI, isophorone diisocyanate), 4,4′-diisocyanato-dicyclohexyl-methane, 4,4′-diisocyanato-dicyclohexylpropane-(2,2), 1,4-diisocyanatobenzene, 2,4-diisocyanatotoluene, 2,6-diisocyanatotoluene, 4,4′-diisocyanato-diphenylmethane, 2,2′- and 2,4′-diisocyanato-diphenylmethane, tetramethyl xylylene diisocyanate, p-xylylene diisocyanate, p-isopropylidene diisocyanate and mixtures of these compounds.

In addition to these simple diisocyanates, also suitable are those polyisocyanates which contain hetero atoms in the radical linking the isocyanate groups and/or have a functionality of more than 2 isocyanate groups in each molecule. The first are for example polyisocyanates which are obtained by modifying simple aliphatic, cycloaliphatic, araliphatic and/or aromatic diisocyanates and which comprise at least two diisocyanates with a uretdione, isocyanurate, urethane, allophanate, biuret, carbodiimide, iminooxadiazinedione and/or oxadiazinetrione structure. As an example of a non-modified polyisocyanate having more than 2 isocyanate groups in each molecule there may for example be mentioned 4-isocyanatomethyl-1,8-octane diisocyanate (nonane triisocyanate).

Preferred diisocyanates (B) are hexamethylene diisocyanate (HDI), dodecamethylene diisocyanate, 1,4-diisocyanato-cyclohexane, 1-isocyanato-3,3,5-trimethyl-5-isocyanatomethyl-cyclohexane (IPDI), 4,4′-diisocyanato-dicyclohexyl-methane, 2,4-diisocyanatotoluene, 2,6-diisocyanatotoluene, 4,4′-diisocyanato-diphenylmethane, 2,2′- and 2,4′-diisocyanato-diphenylmethane and mixtures of these compounds.

The content of component (B) in the polyurethane according to this disclosure is from 5 to 60, preferably from 6 to 45, and particularly preferably from 7 to 25 wt. %.

Suitable polyisocyanates are available under the DESMODUR and BAYHYDUR names from Covestro.

Suitable components (C) are for example components containing sulfonate or carboxylate groups, such as diamine compounds or dihydroxyl compounds which additionally contain sulfonate and/or carboxylate groups, such as the sodium, lithium, potassium, t-amine salts of N-(2-aminoethyl)-2-aminoethane sulfonic acid, N-(3-aminopropyl)-2-aminoethane sulfonic acid, N-(3-aminopropyl)-3-aminopropane sulfonic acid, N-(2-aminoethyl)-3-aminopropane sulfonic acid, analogous carboxylic acids, dimethylol propionic acid, dimethylol butyric acid, the reaction products from a Michael addition of 1 mol of diamine such as 1,2-ethane diamine or isophorone diamine with 2 mol of acrylic acid or maleic acid.

The acids are frequently used directly in the form of their salt as a sulfonate or carboxylate. However, it is also possible to add the neutralizing agent needed for formation of the salt in portions or in its entirety only during or after the polyurethanes have been prepared.

For forming salts, particularly suitable and preferred tert. amines are for example triethylamine, dimethyl cyclohexylamine and ethyl diisopropylamine. It is also possible to use other amines for the salt formation, such as ammonia, diethanolamine, triethanolamine, dimethylethanolamine, methyldiethanolamine, aminomethyl propanol, and also mixtures of the said and indeed other amines. It is sensible to add these amines only after the prepolymer has been formed.

It is also possible to use other neutralizing agents, such as sodium, potassium, lithium or calcium hydroxide for neutralizing purposes.

Other suitable components (C) are mono- or difunctional polyethers which have a non-ionic hydophilising action and are based on ethylene oxide polymers or ethylene oxide/propylene oxide copolymers which are started on alcohols or amines, such as POLYETHER LB 25 (Covestro AG) or MPEG 750: methoxypolyethylene glycol, molecular weight 750 g/mol (e.g. PLURIOL 750, BASF AG).

Preferably, components (C) are N-(2-aminoethyl)-2-aminoethane sulfonate and the salts of or dimethylol propionic acid and dimethylol butyric acid.

Preferably, the content of component (C) in the polyurethane according to this disclosure is 0.1 to 15 wt. %, particularly preferably 0.5 to 10 wt. %, very particularly preferably 0.8 to 5 wt. % and even more particularly preferably 0.9 to 3.0 wt. %.

Suitable components (D) are mono-, di-, trifunctional amines and/or mono-, di-, trifunctional hydroxylamines, such as aliphatic and/or alicyclic primary and/or secondary monoamines such as ethylamine, diethylamine, isomeric propyl and butyl amines, higher linear aliphatic monoamines and cycloaliphatic monoamines such as cyclohexylamine. Further examples are amino alcohols, that is compounds which contain amino and hydroxyl groups in one molecule, such as ethanolamine, N-methyl ethanolamine, diethanolamine, diisopropanolamine, 1,3-diamino-2-propanol, N-(2-hydroxyethyl)-ethylene diamine, N,N-bis(2-hydroxyethyl)-ethylene diamine and 2-propanolamine. Further examples are diamines and triamines, such as 1,2-ethane diamine, 1,6-hexamethylene diamine, 1-amino-3,3,5-trimethyl-5-aminomethyl cyclohexane (isophorone diamine), piperazine, 1,4-diamino cyclohexane, bis-(4-am inocyclohexyl)-methane and diethylene triamine. Also possible are adipic acid dihydrazide, hydrazine and hydrazine hydrate. Mixtures of a plurality of the compounds (D), optionally also those with compounds that are not mentioned, may also be used.

Preferred components (D) are 1,2-ethane diamine, 1-amino-3,3,5-trimethyl-5-aminomethyl cyclohexane, diethylene triamine, diethanolamine, ethanolamine, N-(2-hydroxyethyl)-ethylene diamine and N,N-bis(2-hydroxyethyl)-ethylene diamine.

Compounds (D) preferably serve as chain extenders for creating higher molecular weights or as monofunctional compounds for limiting molecular weights and/or optionally additionally for incorporating further reactive groups, such as free hydroxyl groups as further crosslink points.

Preferably, the content of component (D) in the polyurethane according to this disclosure is from 0 to 10, particularly preferably from 0 to 5, and most particularly preferably from 0.2 to 3 wt. %.

Component (E) which may optionally also be used may for example be aliphatic, cycloaliphatic or aromatic monoalcohols having 2 to 22 C atoms, such as ethanol, butanol, hexanol, cyclohexanol, isobutanol, benzyl alcohol, stearyl alcohol, 2-ethyl ethanol, cyclohexanol; blocking agents which are conventional for isocyanate groups and may be split again at elevated temperature, such as butanone oxime, dimethylpyrazole, caprolactam, malonic esters, triazole, dimethyl triazole, t-butyl-benzyl amine, cyclopentanone carboxyethyl ester.

Preferably, the content of components (E) in the polyurethane according to this disclosure may be in quantities from 0 to 20, most preferably from 0 to 10 wt. %.

The polyurethane polymers used according to this disclosure may contain di- or higher-functional polyester polyols (A), based on linear dicarboxylic acids and/or derivatives thereof, such as anhydrides, esters or acid chlorides and aliphatic or cycloaliphatic, linear or branched polyols. These are used in quantities of at least 80 mol %, preferably from 85 to 100 mol %, particularly preferably from 90 to 100 mol %, in relation to the total quantity of all carboxylic acids.

Optionally, other aliphatic, cycloaliphatic or aromatic dicarboxylic acids may also be used. Examples of such dicarboxylic acids are glutaric acid, azelaic acid, 1,4-, 1,3- or 1,2-cyclohexane dicarboxylic acid, terephthalic acid or isophthalic acid. These are used in quantities of at most 20 mol %, preferably from 0 to 15 mol %, particularly preferably from 0 to 10 mol %, in relation to the total quantity of all carboxylic acids.

Preferred polyol components for the polyesters (A) are selected from the group comprising monoethylene glycol, propanediol-1,3, butanediol-1,4, pentanediol-1,5, hexanediol-1,6 and neopentyl glycol, and particularly preferred as the polyol component are butanediol-1,4 and hexanediol-1,6, and most particularly preferred is butanediol-1,4. These are preferably used in quantities of at least 80 mol %, particularly preferably from 90 to 100 mol %, in relation to the total quantity of all polyols.

Optionally, other aliphatic or cycloaliphatic, linear or branched polyols may also be used. Examples of polyols of this kind are diethylene glycol, hydroxypivalic acid neopentyl glycol, cyclohexane dimethanol, pentanediol-1,5, pentanediol-1,2, nonanediol-1,9, trimethylol propane, glycerine or pentaerythritol. These are used in quantities of preferably at most 20 mol %, particularly preferably from 0 to 10 mol %, in relation to the total quantity of all polyols.

Mixtures of two or more polyesters (A) of this kind are also possible.

The polyurethane dispersions according to this disclosure preferably have solids contents of preferably from 15 to 70 wt. %, particularly preferably from 25 to 60 wt. %, and most particularly preferably from 30 to 50 wt. %. The pH is preferably in the range from 4 to 11, particularly preferably from 6 to 10.

The waterborne polyurethane dispersions useful in this disclosure may be prepared such that the components (A), (B) optionally (C) and optionally (E) are reacted in a single-stage or multi-stage reaction to give an isocyanate-functional prepolymer which is then, optionally with component (C) and optionally (D), reacted in a single-stage or two-stage reaction and then dispersed in or using water, wherein solvent used therein may optionally be removed, partially or entirely, by distillation during or after the dispersion.

The waterborne polyurethane or polyurethane urea dispersions according to this disclosure may be prepared in one or more stages in a homogeneous or, in the case of a multi-stage reaction, partly in a disperse phase. After the polyaddition has been partially or entirely performed, a step of dispersion, emulsification or solution is carried out. Then a further polyaddition or modification in a disperse phase is optionally carried out. For the preparation, any methods known from the prior art may be used, such as the emulsifier/shear force method, acetone method, prepolymer mixing method, melting/emulsifying method, ketimine method and spontaneous dispersion of solids method, or derivatives thereof. A summary of these methods can be found in Methoden der organischen Chemie (Houben-Weyl, supplemental volumes to the 4th edition, Volume E20, H. Bartl and J. Falbe, Stuttgart, New York, Thieme 1987, pp. 1671-1682). The melting/emulsifying method, prepolymer mixing method and acetone method are preferred. The acetone method is particularly preferred.

In principle, it is possible to measure out all the components—all the hydroxy-functional components—together, and then to add all the isocyanate-functional components and react them to give an isocyanate-functional polyurethane, which is then reacted with the amino-functional components. Preparation is also possible the other way round, that is taking the isocyanate component, adding the hydroxy-functional components, reacting to give polyurethane and then reacting with the amino-functional components to give the end product.

Conventionally, all or some of the hydroxy-functional components (A), optionally (C) and optionally (E) for preparing a polyurethane prepolymer are put into the reactor, optionally diluted with a water-miscible solvent which is, however, inert to isocyanate groups, and then homogenised. Then the component (B) is added at room temperature to 120° C. and an isocyanate-functional polyurethane is prepared. This reaction may be performed in a single stage or in multiple stages. A multi-stage reaction may be carried out for example in that a component (C) and/or (E) is reacted with the isocyanate-functional component (B) and then a component (A) is added thereto and can then be reacted with some of the isocyanate groups that are still present.

Suitable solvents are for example acetone, methyl isobutyl ketone, butanone, tetrahydrofuran, dioxan, acetonitrile, dipropylene glycol dimethyl ether and 1-methyl-2-pyrrolidone, which may be added not only at the start of preparation but optionally also later in portions. Acetone and butanone are preferred. It is possible to perform the reaction at standard pressure or under elevated pressure.

To prepare the prepolymer, the quantities of hydroxyl-functional and, optionally, amino-functional components that are used are such that a ratio of isocyanate of preferably 1.05 to 2.5, particularly preferably 1.15 to 1.95, most particularly preferably 1.2 to 1.7 is produced.

The further reaction, the so-called chain extension, of the isocyanate-functional prepolymer with further hydroxy- and/or amino-functional, preferably only amino-functional components (D) and optionally (C) is performed such that a degree of conversion of preferably 25 to 150%, particularly preferably 40 to 85%, of hydroxyl and/or amino groups in relation to 100% isocyanate groups is selected.

In the case of degrees of conversion greater than 100%, which are possible but less preferred, it is appropriate first to react all the components which are monofunctional for the isocyanate addition reaction with the prepolymer, and then to use the di- or higher-functional chain-extending components to obtain the greatest possible degree of incorporation of all the chain-extending molecules.

Conventionally, the degree of conversion is monitored by tracking the NCO content of the reaction mixture. For this, both spectroscopic measurements, such as infrared or near infrared spectra or determination of the refractive index, and chemical analyses such as the titration of samples may be carried out.

To accelerate the isocyanate addition reaction, conventional catalysts such as those known to those skilled in the art for acceleration of NCO—OH reactions may be used. Examples are triethylamine, 1,4-diazabicyclo-[2,2,2]octane, dibutyltin oxide, tin dioctoate or dibutyltin dilaurate, tin-bis-(2-ethyl hexanoate), zinc dioctoate, zinc-bis-(2-ethyl hexanoate) or other organo-metallic compounds.

The chain of the isocyanate-functional prepolymer may be extended with the component (D) and optionally (C) before, during or after dispersion. Preferably, the chain extension is carried out before dispersion. If component (C) is used as the chain-extending component, then it is imperative that chain extension with this component be carried out before the dispersion step. Conventionally, the chain extension is carried out at temperatures of 10 to 100° C., preferably from 25 to 60° C.

The term chain extension, in the context of the present disclosure, also includes the reactions of optionally monofunctional components (D) which, as a result of their monofunctionality, act as chain terminators and thus result not in an increase but a limitation of the molecular weight.

The components of chain extension may be added to the reaction mixture diluted with organic solvents and/or water. They may be added successively, in any order, or at the same time by adding a mixture.

For the purpose of preparing the polyurethane dispersion, the prepolymer may either be added to the dispersion liquid, optionally under pronounced shear, such as vigorous stirring, or conversely the dispersion liquid is stirred into the prepolymer. Then the chain extension step is carried out, unless this has already been done in the homogeneous phase.

During and/or after dispersion, the organic solvent which is optionally used, such as acetone, is distilled off.

Polyurethane dispersions useful in the practice of the present disclosure may be found under the BAYHYDROL, DISPERCOLL and IMPRANIL tradenames from Covestro.

Plot 210 may be generated and displayed on the ternary map GUI page 200. Illustrations 220, 230, 240, and 250 may be generated and displayed on the ternary map GUI page 200. The illustrations 220, 230, 240, and 250 may be depicted as gauges and correspond to different predicted properties of a material composition. Plot 210 may define a geometric shape and include a plurality of points arranged in a matrix. Each of the points may define a value for at least two variables and a predicted value of the property of the material for the plot. A visual representation of the predicted value of the property of the material for at least some of the plurality of points in a range of indicia, wherein the range of indicia represents a range of predicted values of the property may be displayed on the ternary map GUI page 200. A point 212 is displayed on plot 210, such as the heat map 216 for example. The plot 210 may also have a spider-plot 213a, 213b, 213c, that illustrates the value of each of the components 218a, 218b, and 218c. The spider-plot 213a, 213b, 213c provides a visual representation of the components 218a, 218b, and 218c that make up the composition.

As shown in the example of FIG. 5, the ternary map GUI page 200 may include a ternary map GUI that presents, in one aspect, a plot defining a geometric shape such as ternary plot 210 and four gauges 220, 230, 240, 250 for four properties (Soft Feel 227, DEET 237, 5 Finger Scratch 247, and Drag 257). The ternary map GUI page 200 may include a navigation bar 204 and tabs 201a, 201b, and 201c. The tabs 201a, 201b, and 201c correspond to different pages of the ternary map GUI page 200. Plot 210 includes a plurality of points arranged in a matrix where each point defines a value for at least two variables and a predicted value of a property of the material. A visual representation of the predicted value of the property of the material for at least some of the plurality of points in a range of indicia is displayed on the ternary map GUI page 200 in the four gauges 220, 230, 240, 250. The range of indicia represents a range of predicted values of the property. In one aspect, at least one of the at least two variables is an independent variable.

In one aspect, the ternary plot 210 may be generated by a model. The model may be generated, for example, based on design of experiments, regression analysis of a data set, an equation, machine learning, or artificial intelligence, and/or any combination thereof.

In the example illustrated in FIG. 5, ternary plot 210 represents a heat map 216 showing the distribution of the property depicted by the heat map 216 for all possible combinations of components 218a, 218b, and 218c corresponding to vertices of the ternary plot 210. In other aspects, the ternary map GUI 200 may present ternary plots for additional or fewer properties, without limitation. By way of example, the ternary plot 210 represents a heat map 216 for Soft Feel 227, property 1. When the illustration 220 is selected by a user, the ternary plot 210 illustrates the heat map 216 for the Soft Feel 227, property 1. In addition or in the alternative, when a user selects illustration 230, 240, or 250, the ternary plot 210 depicts a heat map corresponding to the selected illustration and property. The use of a central ternary plot 210 and illustrations 220, 230, 240, and 250 permits the display of predicted properties of the combinations of components 218a, 218b, and 218c and various properties in a convenient graphical display.

In one aspect, the geometric shape defines a closed shape in Euclidian space. In one aspect, the closed shape defines a polygon. In the example illustrated in FIG. 5, the ternary plot 210 generated by the ternary map GUI 200 is a triangle, with each vertex corresponding to a particular component of the composition of interest. In the ternary map GUI 200, the top vertex corresponds to component 218c, the bottom right vertex corresponds to component 218a, and the bottom left vertex corresponds to component 218b. Each component 218a, 218b, 218c represents an available resin. Where the polygon is a triangle as shown in FIG. 5, each of the points defines a value for three variables, where each variable is, for example, a value representing an amount of a component of a composition, such as the relative amounts of component 218a, components 218b, and component 218c to each other. In one aspect, the amounts are expressed as a percentage and a sum of the amounts is 100%.

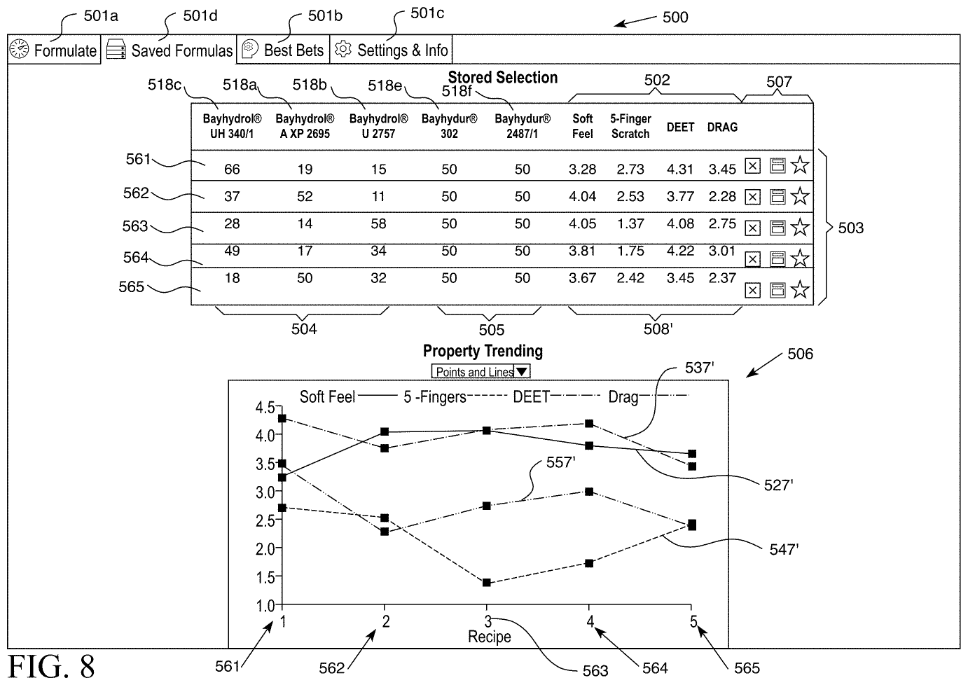

A heat map 216 is a graphical representation of data, where the individual values contained in a matrix are represented as colors as shown, for example, in the corresponding color scale 214. A unique color scale 214 may be provided for each property 227, 237, 247, and 257. When a user selects a particular illustration 220, 230, 240, or 250, the corresponding color scale is illustrated on the ternary plot 210. With respect to the ternary map GUI 200 the various colors represent a range of measured values of the property described by the heat map 216 and the corresponding selected property 227, 237, 247, or 257. The measured values may be stored in a data table 502 as shown in FIG. 8, for example. The user may select a color scheme of choice by choosing one of ten options, for example, provided in a color scheme dropdown menu 703, shown in FIG. 10. As shown, Color 1 is the current selection. Referring to FIG. 5, the desired composition may be saved to data table 502 by selecting a Save Button 211a which saves the current composition configuration. In the alternative, the user may select the Clear button 211b, that will clear the currently selected formulation from the ternary map GUI page 200. In addition or in the alternative, the user may select the Specify button 211c to specifically input the desired amounts of components 218c, 218a, and 218e.

Turning back to FIG. 5, the position of the chosen combination on the ternary plot 210 is displayed as a point 212 on the heat map 216. The point 212 provides the values for the relative amount of the corresponding components 218a, 218b, and 218c. As described in more detail below, as the position of the point 212 is moved within the heat map 216 section of the ternary plot 210, the positioning of the point 212 causes the values in the selected illustration, for example illustration 220 in FIG. 5 to be highlighted in color and dynamically change. Similarly, while not highlighted in color such as the selected illustration 220, the illustrations 230, 240, and 250 remain grayed out, but also change in the depiction of the predicted properties of the composition as the point 212 is moved around the ternary plot 210 to select different combinations of the components 218c, 218a, and 218e.

Based on the position of the point 212 on the heat map 216 the ternary map GUI 200 provides a graphical display in each of the illustrations 220, 230, 240, and 250 of the corresponding property of the material for that point. As shown in FIG. 5, the ternary plot 210 displays the property above a horizontal bar 215 in the color scale 214 area and next to a box element 217 where the color of the horizontal bar 215 and the box element 217 corresponds to the color of the property for the material as determined by the underlying software, based on the position of the point 212. As illustrated in the example of FIG. 5, based on the current position of the point 212, the value of the Soft Feel 227 property is 3.87, the value of the DEET 237 property is 3.85, the value of the 5 Finger Scratch 247 property is 2.19, and the value of the Drag 257 property is 2.42. In addition, each of the values of the properties 227, 237, 247, 257 corresponds to a dynamic gauge 221, 231, 241, and 251, visual illustration 222, 232, 242, and 252, and property descriptor 223, 233, 243, and 253. In addition, the values of the property based upon the location of the point 212 are dynamically updated in the property values 225, 235, 245, and 255.

When the point 212 on the ternary plot 210 is dynamically moved, the visual illustrations 222, 232, 242, and 252, and property descriptors 223, 233, 243, and 253 are dynamically updated to correspond the predicted property value of the overall composition.

In the embodiment illustrated in FIG. 5, the illustration 220 is selected and depicts dynamically changing gauge 221. The gauge 221 shows the range of the Soft Feel 227 property as the point 212 is dynamically changed on the ternary plot 210. In the alternative, a user may select illustration 230, 240, or 250. When each illustration is selected the heat map 216 is updated on the central ternary plot 210 to illustrate the property ranges associated with the selected illustration. When a particular illustration 220, 230, 240, or 250 is not selected, it may remain in a grayscale. When the illustrations 220, 230, 240, or 250 are not selected, as the point 212 is moved around the ternary plot 210, the gauges 221, 231, 241, and 251 dynamically update the corresponding property 227, 237, 247, or 257 based upon the combination of the components 218a, 218b, and 218c.

A composition may comprise various components 218a, 218b, and 218c. In addition or in the alternative, the composition may comprise additional components. The additional components may be selected using the slider 219 in various amounts and proportions. The additional components that are selected by the slider 219 are not modified when the point 212 is dynamically moved on the ternary plot 210.

When illustration 220 is selected, the dynamic movement of point 212 on the ternary plot 210 causes the gauge indication 226 to change colors corresponding to the color of the heat map 216. The color of the heat map 216 corresponds to the color scale 214 and the horizontal bar 215. The gauge indication 226, horizontal bar 215, and the box element 217 are dynamically updated based upon the positioning of the point 212 on the ternary plot 210. Similarly, when illustrations 230, 240, or 250 are selected, the color of the gauge indications 236, 246, or 256 will be dynamically updated as the point 212 is moved throughout the ternary plot 210.

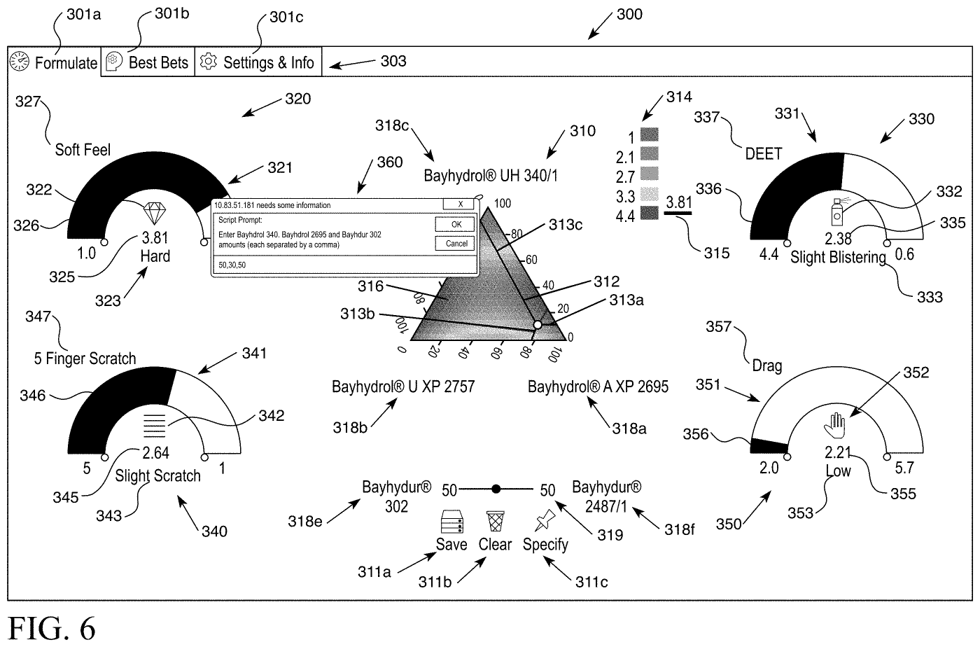

FIG. 6 is a graphical depiction of a ternary plot 300 for a property showing the location of a point 312 on the provided heat map 316 according to one aspect of this disclosure. The ternary plot 300 represents a heat map 316 and is similar to the ternary plot 200 shown in FIG. 5. The ternary plot 300 includes three vertices 318a, 318b, 318c and defines three scales A-Scale, B-Scale, C-Scale. An element such as a color scale 314 represents a color for each predicted value of the property. While the scale 314 values vary for each predicted property value, each scale begins with a blue color and progresses to green, yellow, and then magenta as the value of that property changes. For example, when looking at the ternary plot 300, the illustration 320 has been selected to depict the Soft Feel 327 property of approximately 3.81, as depicted above horizontal bar 315. As the point 312 is moved throughout the heat-map 316, the property indications illustrated in horizontal bar 315, gauge indication 326, visual illustration 322, property value 325, and property descriptor 323 are dynamically updated.

In addition, or in the alternative, pop-up box 360 can allow for user input of specific combinations of compositions 318c, 318a, and 318e. To access the pop-up box 360, the user selects the Specify button 311c which opens the pop-up box 360 to allow the user to specify the desired makeup of the composition. The user may input the specific combination of compositions 318c, 318a, and 318e using comma-delineated notation. When selecting the combination of compositions 318c, 318a, and 318e using the pop-up box 360, the dynamically updating illustrations will be update once the combination is accepted by the user. The point 312 will be updated to the specific location corresponding to the selected composition on the ternary plot 310 and the property indications illustrated in horizontal bar 315, gauge indication 326, visual illustration 322, property value 325, and property descriptor 323 will be dynamically updated.

As the point 312 is moved throughout the heat-map 316, the color changes signify a change in the predicted value of the selected illustration's property. The selected point 312 may be moved within the heat map 316 by clicking a curser on the point 312 and dragging the point 312 with a curser to a desired location within the heat map 316. Clicking and dragging the point 312 dynamically updates the location of the point 312 and an element as the point 312 is dragged over the visual representation such as the heat map 316. The element such as the scale 314 may include a numeric value or a descriptor of the property. In one aspect, the element includes indicia, such as the range of colors that represents the predicted value or the descriptor of the property in the visual representation. Examples of suitable descriptors include, but are not limited to, silky, velvety, soft, hard, suede, rubbery, drag (e.g., hand), slippery, lubricious, tough, dead, prickly, wetness, dryness, powdery, supple.

In another aspect of this disclosure, plot 810 may be generated and displayed on the ternary map GUI page 800. Illustrations 820, 830, 840, and 850 may be generated and displayed on the ternary map GUI page 800. The illustrations 820, 830, 840, and 850 may be depicted as gauges and correspond to different predicted properties of a material composition. Plot 810 may define a geometric shape and include a plurality of points arranged in a matrix. Each of the points may define a value for at least two variables and a predicted value of the property of the material for the plot. A visual representation of the predicted value of the property of the material for at least some of the plurality of points in a range of indicia, wherein the range of indicia represents a range of predicted values of the property may be displayed on the ternary map GUI page 800. A point 812 is displayed on plot 810, such as the heat map 816 for example. The plot 810 may also have a spider-plot 813a, 813b, 813c, that illustrates the value of each of the components 818a, 818b, and 818c. The spider-plot 813a, 813b, 813c provides a visual representation of the components 818a, 818b, and 818c that make up the composition.

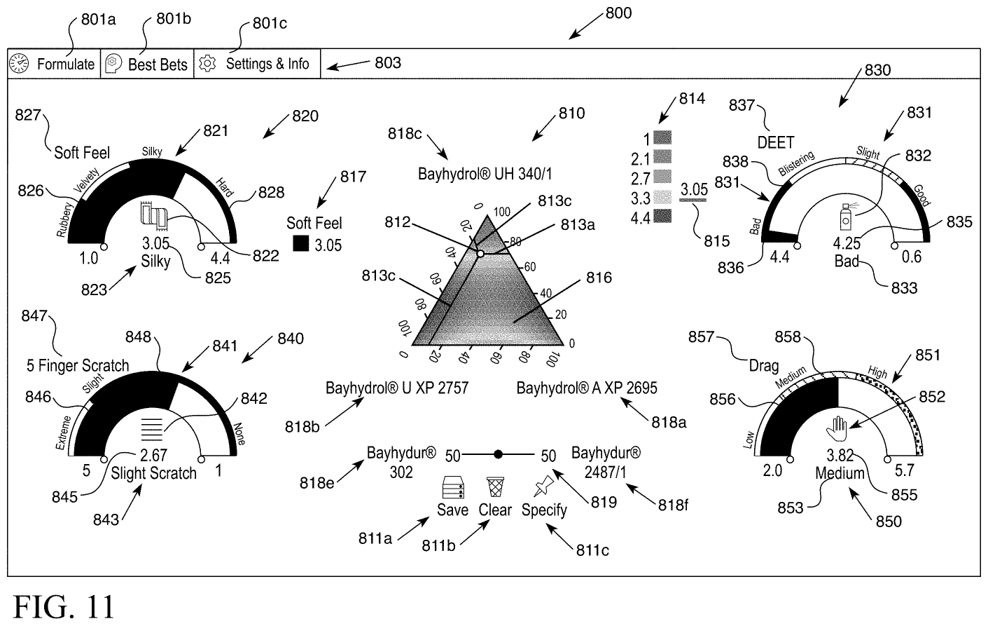

As shown in the example of FIG. 11, the ternary map GUI page 800 may include a ternary map GUI that presents, in one aspect, a plot defining a geometric shape such as ternary plot 810 and four gauges 820, 830, 840, 850 for four properties (Soft Feel 827, DEET 837, 5 Finger Scratch 847, and Drag 857). The ternary map GUI page 800 may include a navigation bar 804 and tabs 801a, 801b, and 801c. The tabs 801a, 801b, and 801c correspond to different pages of the ternary map GUI page 800. Plot 810 includes a plurality of points arranged in a matrix where each point defines a value for at least two variables and a predicted value of a property of the material. A visual representation of the predicted value of the property of the material for at least some of the plurality of points in a range of indicia is displayed on the ternary map GUI page 800 in the four gauges 820, 830, 840, 850. The range of indicia represents a range of predicted values of the property. In one aspect, at least one of the at least two variables is an independent variable.

In one aspect, the ternary plot 810 may be generated by a model. The model may be generated, for example, based on design of experiments, regression analysis of a data set, an equation, machine learning, or artificial intelligence, and/or any combination thereof.

In the example illustrated in FIG. 11, the ternary plot 810 represents a heat map 816 showing the distribution of the property depicted by the heat map 816 for all possible combinations of components 818a, 818b, and 818c corresponding to vertices of the ternary plot 810. In other aspects, the ternary map GUI 800 may present ternary plots for additional or fewer properties, without limitation. By way of example, the ternary plot 810 represents a heat map 816 for Soft Feel 827, property 1. When the illustration 820 is selected by a user, the ternary plot 810 illustrates the heat map 816 for the Soft Feel 827, property 1. In addition or in the alternative, when a user selects illustration 830, 840, or 850, the ternary plot 810 depicts a heat map corresponding to the selected illustration and property. The use of a central ternary plot 810 and illustrations 820, 830, 840, and 850 permits the display of predicted properties of the combinations of components 818a, 818b, and 818c.

In one aspect, the geometric shape defines a closed shape in Euclidian space. In one aspect, the closed shape defines a polygon. In the example illustrated in FIG. 11, the ternary plot 810 generated by the ternary map GUI 800 is a triangle, with each vertex corresponding to a particular component of the composition of interest. In the ternary map GUI 800, the top vertex corresponds to component 818c, the bottom right vertex corresponds to component 818a, and the bottom left vertex corresponds to component 818b. Each component 818a, 818b, 818c represents an available resin. Where the polygon is a triangle as shown in FIG. 11, each of the points defines a value for three variables, where each variable is, for example, a value representing an amount of a component of a composition, such as the relative amounts of component 818a, components 818b, and component 818c to each other. In one aspect, the amounts are expressed as a percentage and a sum of the amounts is 100%.

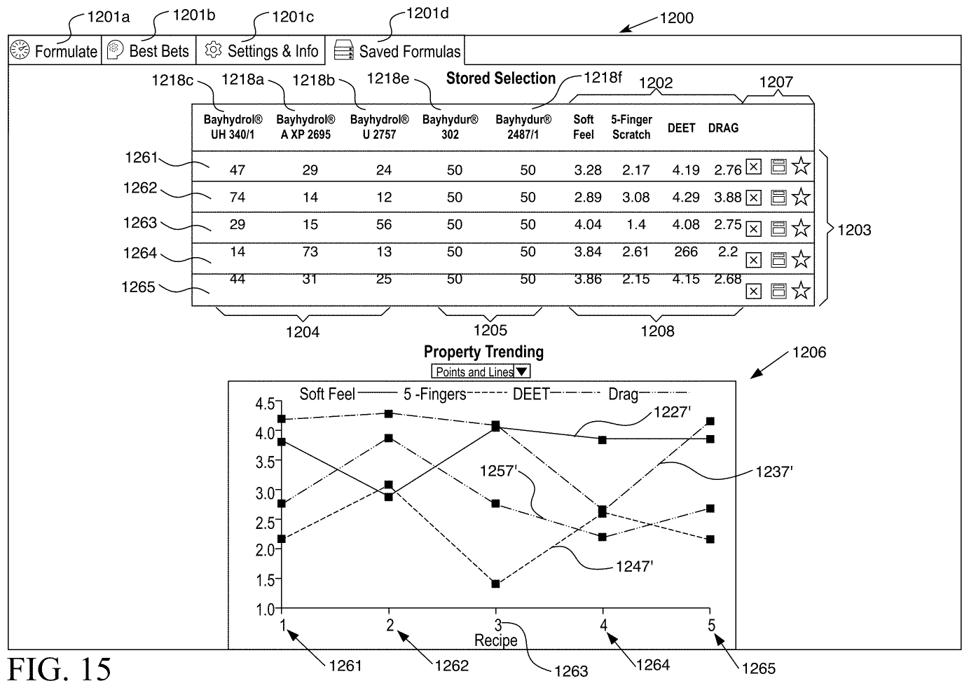

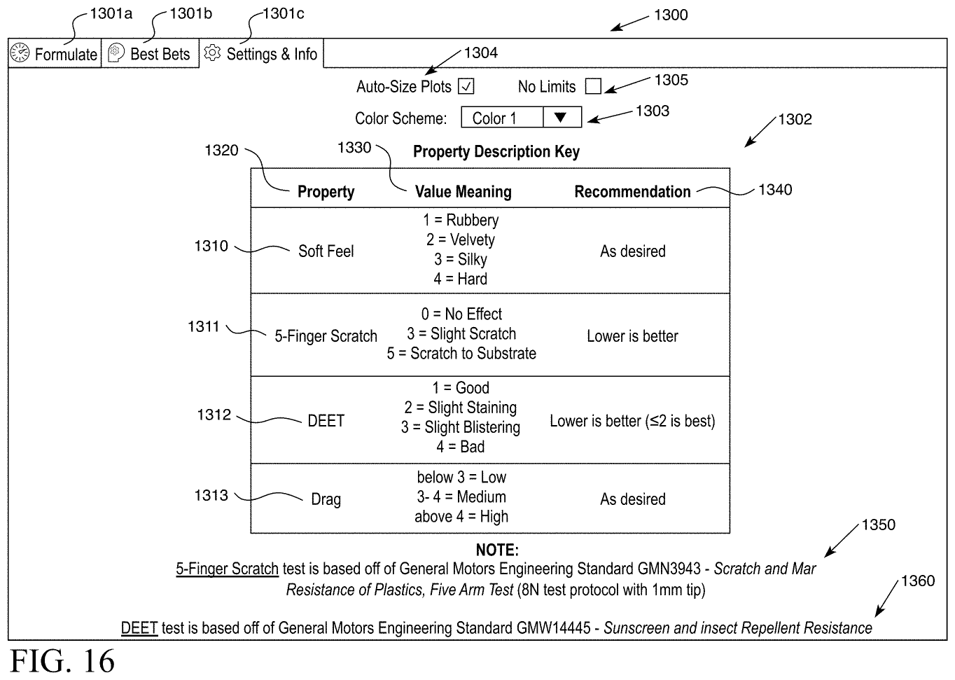

A heat map 816 is a graphical representation of data, where the individual values contained in a matrix are represented as colors as shown, for example, in the corresponding color scale 814. A unique color scale 814 may be provided for each property 827, 837, 847, and 857. When a user selects a particular illustration 820, 830, 840, or 850, the ternary plot 810 is updated. The updates include updating the model equation corresponding to the selected illustration, updating the color scale, and generating the corresponding heat map to visually display on the ternary plot 810. With respect to the ternary map GUI 800, the various colors represent a range of measured values of the property described by the heat map 216 and the corresponding selected property 827, 837, 847, or 857. The measured values may be stored in a data table 1202 as shown in FIG. 15, for example. The user may select a color scheme of choice by choosing one of ten options, for example, provided in a color scheme dropdown menu 1303, shown in FIG. 16. As shown, Color 1 is the current selection. Referring to FIG. 11, the desired composition may be saved to data table 1202 by selecting Save button 811a which saves the current composition configuration. In the alternative, the user may select the Clear button 811b, that will clear the currently selected formulation from the ternary map GUI page 800. In addition or in the alternative, the user may select the Specify button 811c to specifically input the desired amounts of components 818c, 818a, and 818e.

Turning back to FIG. 11, the position of the chosen combination on the ternary plot 810 is displayed as a point 812 on the heat map 816. The point 812 provides the values for the relative amount of the corresponding components 818a, 818b, and 818c. As described in more detail below, as the position of the point 812 is moved within the heat map 816 section of the ternary plot 810, the positioning of the point 812 causes the values in the selected illustration, for example illustration 820 in FIG. 11 to be highlighted in color and dynamically change. Similarly, while not highlighted in color such as the selected illustration 820, the illustrations 830, 840, and 850 remain grayed out, but also change in the depiction of the predicted properties of the composition as the point 812 is moved around the ternary plot 810 to select different combinations of the components 818a, 818b, and 818c.

Based on the position of the point 812 on the heat map 816 the ternary map GUI 800 provides a graphical display in each of the illustrations 820, 830, 840, and 850 of the corresponding property of the material for that point. As shown in FIG. 11, the ternary plot 810 displays the property above a horizontal bar 815 in the color scale 814 area and next to a box element 817 where the color of the horizontal bar 815 and the box element 817 corresponds to the color of the property for the material as determined by the underlying software based on the position of the point 812. As illustrated in the example of FIG. 11, based on the current position of the point 812, the value of the Soft Feel 827 property is 3.05, the value of the DEET 837 property is 4.25, the value of the 5 Finger Scratch 847 property is 2.67, and the value of the Drag 857 property is 3.82. In addition, each of the values of the properties 827, 837, 847, 857 corresponds to a dynamic gauge 821, 831, 841, and 851, visual illustration 822, 832, 842, and 852, and property descriptor 823, 833, 843, and 853. In addition, the values of the property based upon the location of the point 812 are dynamically updated in the property values 825, 835, 845, and 855.

In addition, dynamic gauge 821, 831, 841, and 851 may include a property range indicator 828, 838, 848, or 858 that provides a visual illustration of the descriptive rage of each respective property. The property range indicator 828, 838, 848, or 858 dynamically change when the gauge indications 826, 836, 846, or 856 move from between properties.

When the point 812 on the ternary plot 810 is dynamically moved, the visual illustrations 822, 832, 842, and 852, and property descriptors 823, 833, 843, and 853 are dynamically updated to correspond to the predicted property value of the overall composition.

In the embodiment illustrated in FIG. 11, the illustration 820 is selected and depicts dynamically changing gauge 821. The gauge 821 shows the range of the Soft Feel 827 property as the point 812 is dynamically changed on the ternary plot 810. In the alternative, a user may select illustration 830, 840, or 850. When each illustration is selected the heat map 816 is updated on the central ternary plot 810 to illustrate the property ranges associated with the selected illustration. When a particular illustration 820, 830, 840, or 850 is not selected, it may remain in a grayscale. When the illustrations 820, 830, 840, or 850 are not selected, as the point 812 is moved around the ternary plot 810, the gauges 821, 831, 841, and 851 dynamically update the corresponding property 827, 837, 847, or 857 based upon the combination of the components 818a, 818b, and 818c.

A composition may comprise various components 818a, 818b, and 818c. In addition or in the alternative, the composition may comprise additional components. The additional components may be selected using the slider 819 in various amounts and proportions. The additional components that are selected by the slider 819 are not modified when the point 812 is dynamically moved on the ternary plot 810.

When illustration 820 is selected, the dynamic movement of point 812 on the ternary plot 810 causes the gauge indication 826 to change colors corresponding to the color of the heat map 816. The color of the heat map 816 corresponds to the color scale 814 and the horizontal bar 815. The gauge indication 826, horizontal bar 815, and the box element 817 are dynamically updated based upon the positioning of the point 812 on the ternary plot 810. Similarly, when illustrations 830, 840, or 850 are selected, the color of the gauge indications 836, 846, or 856 will be dynamically updated as the point 812 is moved throughout the ternary plot 810.

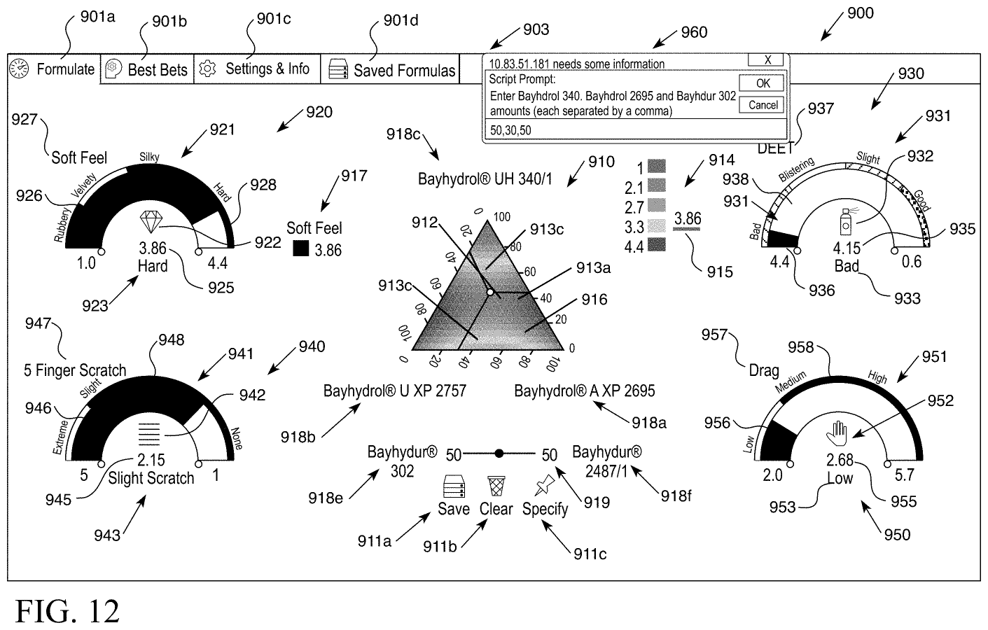

FIG. 12 is a graphical depiction of a ternary plot 900 for a property showing the location of a point 912 on the provided heat map 916 according to one aspect of this disclosure. The ternary plot 900 represents a heat map 916 and is similar to the ternary plot 810 shown in FIG. 11. The ternary plot 900 includes three vertices 918a, 918b, 918c and defines three scales A-Scale, B-Scale, C-Scale. An element such as a color scale 914 represents a color for each predicted value of the property. While the scale 914 values vary for each predicted property value, each scale begins with a blue and progresses to green, yellow, and then magenta as the value of that property changes. For example, when looking at the ternary plot 900, the illustration 920 has been selected to depict the Soft Feel 927 property of approximately 3.86, as depicted above horizontal bar 915. As the point 912 is moved throughout the heat map 916, the property indications illustrated in horizontal bar 915, gauge indication 926, visual illustration 922, property value 925, and property descriptor 923 are dynamically updated.

In addition, or in the alternative, pop-up box 960 can allow for user input of specific combinations of compositions 918c, 918a, and 918e. To access the pop-up box 960, the user selects the Specify button 911c which opens the pop-up box 960 to allow the user to specify the desired makeup of the composition. The user may input the specific combination of compositions 918c, 918a, and 918e using comma-delineated notation. When selecting the combination of compositions 918c, 918a, and 918e using the pop-up box 960, the dynamically updating illustrations will be updated once the combination is accepted by the user. The point 912 will be updated to the specific location on the ternary plot 910 and the property indications illustrated in horizontal bar 915, gauge indication 926, visual illustration 922, property value 925, and property descriptor 923 will be dynamically updated

As the point 912 is moved throughout the heat map 916, the color changes signify a change in the predicted value of the selected illustration's property. The selected point 912 may be moved within the heat map 916 by clicking a curser on the point 912 and dragging the point 912 with a curser to a desired location within the heat map 916. Clicking and dragging the point 912 dynamically updates the location of the point 912 and an element as the point 912 is dragged over the visual representation, such as the heat map 916. The element, such as the scale 914, may include a numeric value or a descriptor of the property. In one aspect, the element includes indicia, such as the range of colors that represents the predicted value or the descriptor of the property in the visual representation. Examples of suitable descriptors include, but are not limited to, silky, velvety, soft, hard, suede, rubbery, drag (e.g., hand), slippery, lubricious, tough, dead, prickly, wetness, dryness, powdery, supple.

### Ternary Map GUI Formulating

In one aspect, the present disclosure provides formulating a composition based on a plurality of properties for at least some of the plurality of points in the range of indicia. Accordingly, once the presented ternary plot 210 shown in FIG. 5 has been identified, the formulating can begin. It should be noted that use of the ternary map GUI 200 can be, and often is, an iterative process that may require some time to understand how the formulating works and to determine which component combinations produce materials, such as coatings, with predicted properties closest to the desired properties.

For example, using the provided point 212, the user can change the ratio of amounts of components, such as resins, used in a formulation. To change the amounts of each component, such as a resin (such as a PUD), a curser is used to click and drag the point 212 on the heat map 216 on ternary plot 210. No matter the illustration 220, 230, 240, or 250 that is selected, the corresponding values of the properties illustrated on each of the remaining illustrations 220, 230, 240, and 250 is updated to the property corresponding to the combination of the compositions 218a, 218b, and 218c.

Referring to FIG. 5, the slider 219 may be used to change the relative amounts of components 218e and 218f, which may represent the isocyanate ratio, by sliding the slider 219 left to decrease the relative amount of 218e (and increase the relative amount of 218f) and to the right to increase the relative amount of 218e (and decrease the relative amount of 218f). Upon changing the isocyanate ratio, the color distribution of the heat map 216 in the ternary plot 210 will update accordingly. If the property of the ternary plot 210 does not change in color distribution with the change in the isocyanate ratio, the specific property is not dependent upon the type and amount of isocyanate used in the formulation.

In another aspect, the present disclosure provides formulating a composition based on a plurality of properties for at least some of the plurality of points in the range of indicia. Accordingly, once the presented ternary plot 810 shown in FIG. 11 has been identified, the formulating can begin. It should be noted that use of the ternary map GUI 800 can be, and often is, an iterative process that may require some time to understand how the formulating works and to determine which component combinations produce materials, such as coatings, with predicted properties closest to the desired properties.

For example, using the provided point 812, the user can change the ratio of amounts of components, such as resins, used in a formulation. To change the amounts of each component, such as a resin (such as a PUD), a curser is used to click and drag the point 812 on the heat map 816 on any of the provided ternary plots 810. No matter the illustration 820, 830, 840, or 850 that is selected, the corresponding values of the properties illustrated on each of the remaining illustrations 820, 830, 840, and 850 is updated to the property corresponding to the combination of the compositions 818a, 818b, and 818c.

Referring to FIG. 11, the slider 819 may be used to change the relative amounts of components 818e and 818f, which may represent the isocyanate ratio, by sliding the slider 819 left to decrease the relative amount of 818e (and increase the relative amount of 818f) and to the right to increase the relative amount of 818e (and decrease the relative amount of 818f). Upon changing the isocyanate ratio, the color distribution of the heat map 816 in the ternary plot 810 will update accordingly. If the property of the ternary plot 810 does not change in color distribution with the change in the isocyanate ratio, the specific property is not dependent upon the type and amount of isocyanate used in the formulation.

### Ternary Map GUI—Formulation Optimization

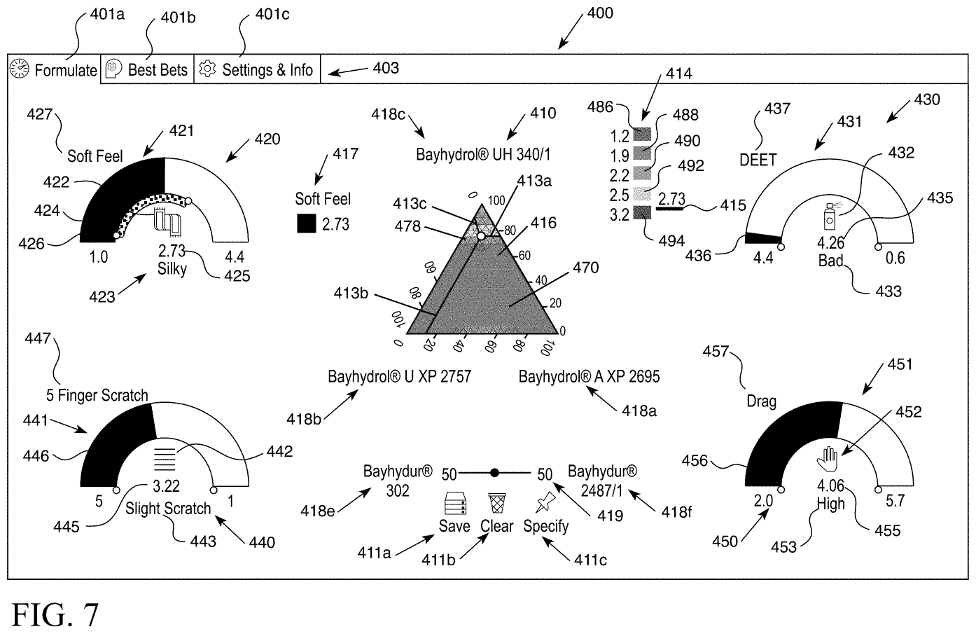

Further, the present disclosure provides optimizing one or more than one property of the material within one or more than one defined range of indicia. A gridded region that represents one or more than one optimized region based on the one or more than one defined range of indicia may be displayed on the ternary map GUI page 400. FIG. 7 is an example of a property optimization GUI window 400 according to one aspect of this disclosure. The optimization ternary map GUI page 400 includes a property optimization selection range 424 which is illustrated in illustration 420. The property optimization selection range 424 may be utilized to isolate products that have a specific set of desired properties. For instance, if the user is looking for a product that has a specific feel, the user can select a rage of the desired property using the property optimization selection range 424. After selecting the optimized range, the ternary plot 410 is updated to illustrate the optimized range by indicating a gridded range 478 that illustrates combinations of the compositions 418a, 418b, and 418c that fall within the desired property and a blocked out range 470 that falls outside of the desired property range. By specifying the property optimization selection range 424, the color gradient of the ternary plot 410 is forced to be contained within the specified range for that property.

An example of an optimized ternary plot 410 is shown in FIG. 7, which is a graphical depiction of an optimization property of a ternary plot 410 according to one aspect of this disclosure. The ternary plot 410 includes a heat map 416 and a gridded region 478 superimposed on the heat map 416. A non-optimized region 470 is shown outside the gridded region 478. A color scale 414 displays the relevant color scheme for, in this case, Soft Feel 427 property, for example, blue 486, green-1 488, green-2 490, yellow 492 and magenta 494. A point 412 is located over the gridded region 478 region causing the value 2.73 to be displayed next to a box element 417 and next a horizontal bar 415. The point 512 can be moved over the heat map 416 by clicking and dragging the point 412 with a curser. The box element 417, the horizontal bar 415, the dynamic gauge 421, gauge indication 426, visual illustration 422, property value 425, and property descriptor 423 dynamically change as the point 412 is moved around the heat map 416.

The color of the box element 414 and the horizontal bar 415 is equal to the property color based on the position of the point 412 on the heat map 416. The color of the box element 414 and the horizontal bar 415 is dynamically updated based on the position of the point 412 as the point 412 is dragged over the heat map 416. In addition, for the illustration 420 the dynamic gauge 421, gauge indication 426, visual illustration 422, property values 425 and property descriptor 423 are also dynamically updated based on the position of the point 412 as the point 412 is dragged over the heat map 416.

To further optimize the ternary plot 410 with a second desired characteristic, the user can select another illustration 420, 430, 440, or 450 and change the corresponding property optimization selection range and repeat the steps discussed above to arrive at the desired properties of the composition.

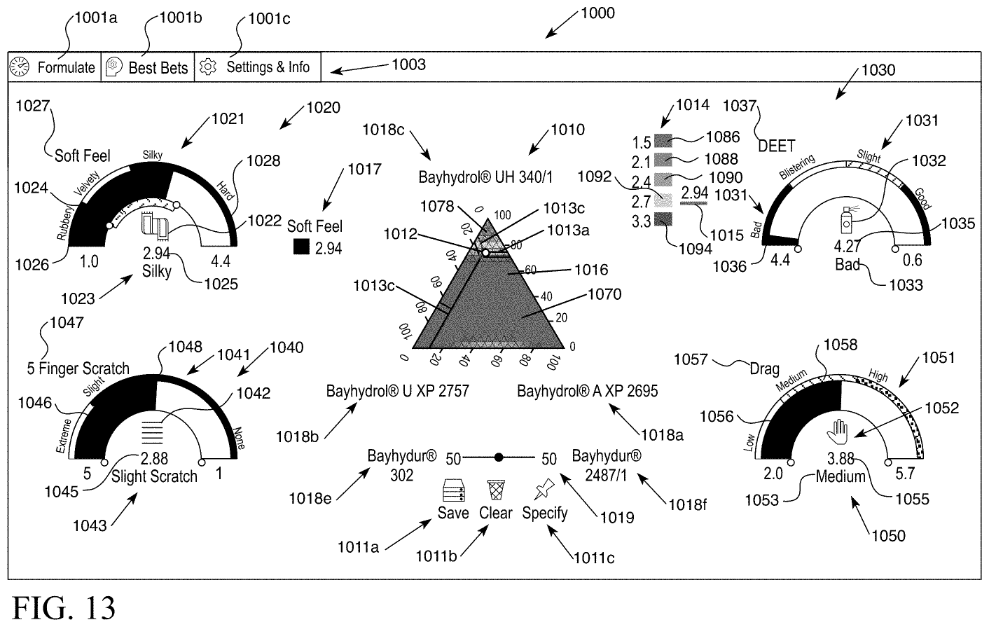

Further, the present disclosure provides optimizing one or more than one property of the material within one or more than one defined range of indicia. A gridded region that represents one or more than one optimized region based on the one or more than one defined range of indicia may be displayed on the ternary map GUI page 1000. FIG. 13 is an example of a property optimization GUI window 1000 according to one aspect of this disclosure. The optimization ternary map GUI page 1000 includes a property optimization selection range 1024 which is illustrated in illustration 1020. The property optimization selection range 1024 may be utilized to isolate products that have a specific set of desired properties. For instance, if the user is looking for a product that has a specific feel, the user can select a rage of the desired property using the property optimization selection range 1024. After selecting the optimized range, the ternary plot 1010 is updated to illustrate the optimized range by indicating a gridded range 1078 that illustrates combinations of the compositions 1018a, 1018b, and 1018c that fall within the desired property and a blocked out range 470 that falls outside of the desired property range. By specifying the property optimization selection range 1024, the color gradient of the ternary plot 1010 is forced to be contained within the specified range for that property.

An example of an optimized ternary plot 1010 is shown in FIG. 13, which is a graphical depiction of an optimization property of a ternary plot 1010 according to one aspect of this disclosure. The ternary plot 1010 includes a heat map 1016 and a gridded region 1078 superimposed on the heat map 1016. A non-optimized region 1070 is shown outside the gridded region 1078. A color scale 1014 displays the relevant color scheme for, in this case, Soft Feel 1027 property, for example, blue 1086, green-1 1088, green-2 1090, yellow 1092, and magenta 1094. A point 1012 is located over the gridded region 1078 region causing the value 2.94 to be displayed next to a box element 1017 and next a horizontal bar 1015. The point 1012 can be moved over the heat map 1016 by clicking and dragging the point 1012 with a curser. The box element 1017, the horizontal bar 1015, the dynamic gauge 1021, gauge indication 1026, visual illustration 1022, property value 1025, and property descriptor 1023 dynamically change as the point 1012 is moved around the heat map 1016.

The color of the box element 1014 and the horizontal bar 1015 is equal to the property color based on the position of the point 1012 on the heat map 1016. The color of the box element 1014 and the horizontal bar 1015 is dynamically updated based on the position of the point 1012 as the point 1012 is dragged over the heat map 1016. In addition, for the illustration 1020 the dynamic gauge 1021, gauge indication 1026, visual illustration 1022, property value 1025, and property descriptor 1023 are also dynamically updated based on the position of the point 1012 as the point 1012 is dragged over the heat map 1016.

To further optimize the ternary plot 1010 with a second desired characteristic, the user can select another illustration 1020, 1030, 1040, or 1050 and change the corresponding property optimization selection range and repeat the steps discussed above to arrive at the desired properties of the composition.

### Ternary Map GUI—Formulation Storage And Export

FIG. 8 is an example of a stored selection GUI 500 showing stored formulations according to one aspect of this disclosure in a stored selection table 502 and a stored property trending chart 506. Once a formulation of interest has been discovered, the user may double click a courser on the point or select the Save button 211a, as illustrated in FIG. 5 to store the component details and their predicted property values for future use/reference. Stored formulations can be displayed in table form on the Saved Formulas tab 501d. If a user is no longer interested in keeping a formulation, the stored formulation can be deleted by clicking the red “x” located at the far right end of the table 502. The user also has the option of exporting the component and predicted property values to Excel by selecting the “Excel Export” link 530.

In the example depicted in FIG. 8, the stored selection table 502 includes selections one through five, 561, 562, 563, 564, and 565 having various values of components 518a, 518b, 518c, 518e, and 518f. The corresponding properties for each of the selections 561, 562, 563, 564, and 565 are illustrated in columns 508. The components 518a, 518b, and 518c represent the active variables 504 that correspond the ternary plots illustrated throughout FIGS. 5-7. The components 518e and 518f represent the stationary variables 505 that may comprise the isocyanate ratio.

The stored property trending chart 506 illustrates the trend of the properties of the stored selections 561, 562, 563, 564, and 565. The stored property trending chart 506 shows the trend of the properties 527′, 537′, 547′, and 557′ as they change for each of the selected compositions 561, 562, 563, 564, and 565.

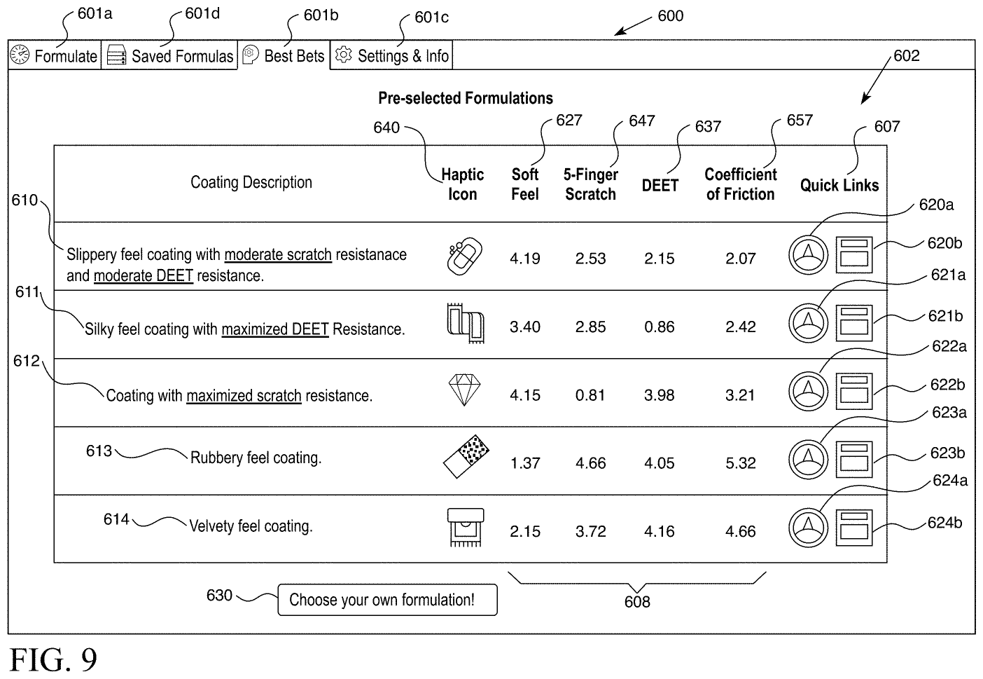

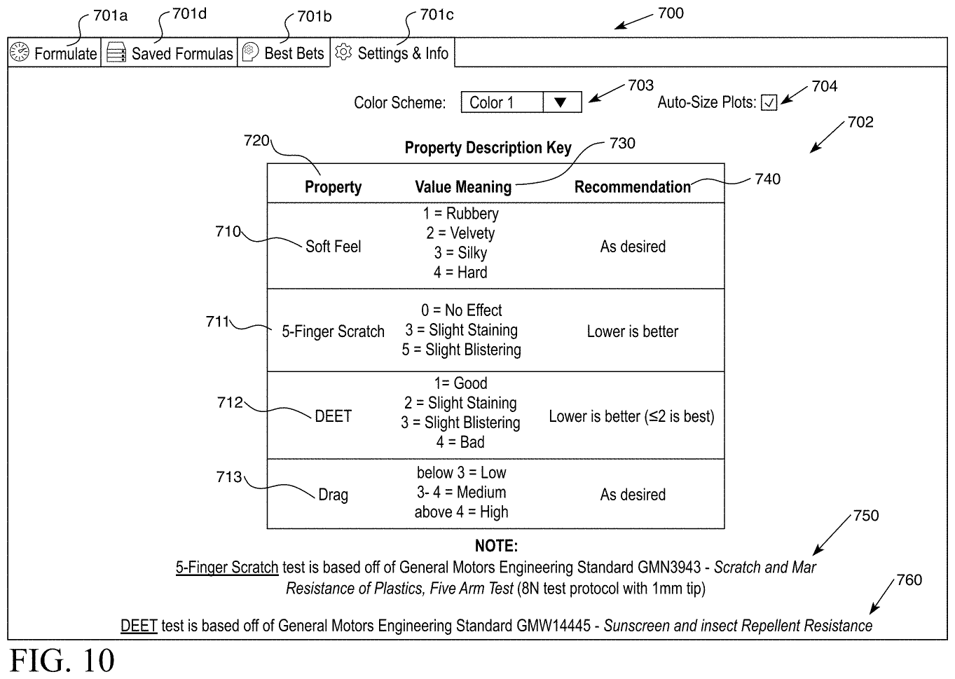

FIG. 9 illustrates a GUI page 600 depicting the Starting Points tab 601b. The Starting Points tab 601b includes table 602 having pre-selected compositions 610, 611, 612, 613, and 614. The table 602 illustrates the corresponding properties 627, 637, 647, and 657 for each of the compositions 610, 611, 612, 613, and 614. The table 602 further includes a haptic icon 640 that provides a visual illustration of the characteristics of the formulas. Section 608 of the table 602 lists the values for each of the properties 627, 637, 647, and 657. The table 602 also includes an option to allow a user to select their own composition using a GUI 200, as seen in FIG. 5, by selecting the Choose your own formulation button 630. The table 607 further includes Quick Links column 607 that includes quick links 620, 621, 622, 623, and 624 which allow a user to select the links to uncover additional information about the compositions 610, 611, 612, 613, and 614, respectively.

FIG. 10 illustrates a GUI 700 depicting the Settings & Info tab 701c. The Settings & Info tab 701c includes a property description key 702. The property description key 702 includes a property column 720 listing properties 710, 711, 712, and 713. The property description key 702 further includes value meaning column 730 which provides a narrative for the value corresponding to each of the properties 710, 711, 712, and 713. The property description key 702 further includes recommendation column 740 which provides a recommendation for which property characteristics are more optimal. The GUI interface 700 also includes a Color Scheme selection drop-down 703 that allows a user to select a desired color scheme for the ternary plots and an auto-size plots feature 704 that automatically sizes the GUI tabs with the selected compositions. The GUI 700 further includes a notes section having notes 750 and 760 which provide a more detailed description of the properties 711 and 712, respectively.

FIG. 15 is an example of a stored selection GUI 1200 showing stored formulations according to one aspect of this disclosure in a stored selection table 1202 and a stored property trending chart 1206. Once a formulation of interest has been discovered, the user may double click a courser on the point or select the Save button 811a, as illustrated in FIG. 11 to store the component details and their predicted property values for future use/reference. Stored formulations can be displayed in table form on the Saved Formulas tab 1201d. If a user is no longer interested in keeping a formulation, the stored formulation can be deleted by clicking the red “x” located at the far right end of the table 1202. The user also has the option of exporting the component and predicted property values to Excel by selecting the “Excel Export” link 1230.

In the example depicted in FIG. 15, the stored selection table 1202 includes selections one through five, 1261, 1262, 1263, 1264, and 1265 having various values of components 1218a, 1218b, 1218c, 1218e and 1218f. The corresponding properties for each of the selections 1261, 1262, 1263, 1264, and 1265 are illustrated in columns 1208. The components 1218a, 1218b, and 1218c represent the active variables 1204 that correspond to the ternary plots illustrated throughout FIGS. 11-13. The components 1218e and 1218f represent the stationary variables 1205 that may comprise the isocyanate ratio.

The stored property trending chart 1206 illustrates the trend of the properties of the stored selections 1261, 1262, 1263, 1264, and 1265. The stored property trending chart 1206 shows the trend of the properties 1227′, 1237′, 1247′, and 1257′ as they change for each of the selected compositions 1261, 1262, 1263, 1264, and 1265.

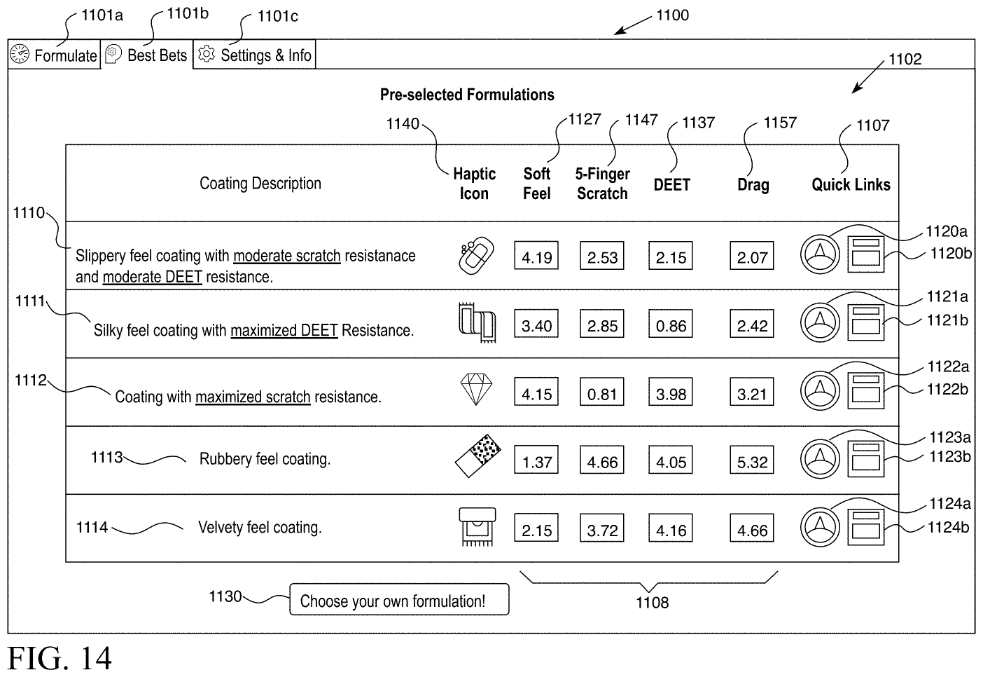

FIG. 14 illustrates a GUI page 1100 depicting the Starting Points tab 1101b. The Starting Points tab 1101b includes table 1102 having pre-selected compositions 1110, 1111, 1112, 1113, and 1114. The table 1102 illustrates the corresponding properties 1127, 1137, 1147, and 1157 for each of the compositions 1110, 1111, 1112, 1113, and 1114. The table 1102 further includes a haptic icon 1140 that provides a visual illustration of the characteristics of the formulas. Section 1108 of the table 1102 lists the values for each of the properties 1127, 1137, 1147, and 1157. The table 1102 also includes an option to allow a user to select their own composition using a GUI 800, as seen in FIG. 11 by selecting the Choose your own formulation button 1130. The table 1107 further includes Quick Links column 1107 that includes quick links 1120a, 1121a, 1122a, 1123a, 1124a, 1120b, 1121b, 1122b, 1123b, and 1124b which allow a user to select the links to uncover additional information about the compositions 1110, 1111, 1112, 1113, and 1114, respectively.

When selected, the first quick links 1120a, 1121a, 1122a, 1123a, and 1124a automatically update the ternary plot 810 in the respective formulation in the Formulate Tab 801a, sending the point to the exact location of the resin combination needed to create the selected coating. When selected, the second quick links 1124a, 1120b, 1121b, 1122b, 1123b, and 1124b allow the user to generate a guide formulation export, based on the composition of the resins for the selected composition 1110, 1111, 1112, 1113, and 1114. The guide formulation export contains detailed instructions of how to produce the coating in the lab, containing mixing instructions, trouble-shooting recommendations, and additive/component levels for all ingredients needed to create the selected coating.

FIG. 16 illustrates a GUI page 1300 depicting the Settings & Info tab 1301c. The Settings & Info tab 1301c includes a property description key 1302. The property description key 1302 includes a property column 1320 listing properties 1310, 1311, 1312, and 1313. The property description key 1302 further includes value meaning column 1330 which provides a narrative for the value corresponding to each of the properties 1310, 1311, 1312, and 1313. The property description key 1302 further includes recommendation column 1340 which provides a recommendation for which property characteristics are more optimal. The GUI interface 1300 also includes a Color Scheme selection drop-down 1303 that allows a user to select a desired color scheme for the ternary plots and an auto-size plots feature 1304 that automatically sizes the GUI tabs with the selected compositions. The GUI 1300 also includes a No Limits feature 1305 that allows the user to hide/show the property optimization selection range 1024 on the GUI 1000. The GUI 1300 further includes a notes section having notes 1350 and 1360 which provide a more detailed description of the properties 1311 and 1312, respectively.

The components include a polyisocyanate component and an isocyanate-reactive component that includes several ingredients such as polyols, monols, blowing agents, catalysts, surfactants, and other additives as described hereinbelow.

Suitable polyisocyanate components to be used as component (1) include, for example, aromatic polyisocyanates characterized by a functionality of greater than or equal to about 2.0. In particular, the suitable polyisocyanates and/or prepolymers thereof to be used as component (1) typically have NCO group contents of greater than about 20%. Suitable aromatic polyisocyanates include toluene diisocyanate including 2,4-toluene diisocyanate, 2,6-toluene diisocyanate and mixtures thereof, diphenylmethane diisocyanate including 2,2′-diphenylmethane diisocyanate, 2,4′-diphenylmethane diisocyanate, 4,4′-diphenylmethane diisocyanate, and isomeric mixtures thereof, polyphenylmethane polyisocyanates, etc. One suitable aromatic polyisocyanate component comprises a mixture of 80% by weight of 2,4-toluene diisocyanate and 20% by weight of 2,6-toluene diisocyanate.

Suitable polyoxyalkylene polyether polyols include those having a hydroxyl functionality of at least about 2. The hydroxyl functionality of the polyoxyalkylene polyether polyols is often less than or equal to about 8, such as less than or equal to about 6 or less than or equal to 4. Suitable polyoxyalkylene polyether polyols may also have functionalities ranging between any combination of these upper and lower values, inclusive, e.g., from at least 2 to no more than 8, such as from at least 2 to no more than 6 or from at least 2 to no more than 4. Typically, the average OH (hydroxyl) numbers of suitable polyoxyalkylene polyether polyols is at least about 20, such as at least 25. Polyoxyalkylene polyether polyols typically also have average OH numbers of less than or equal to 250, such as less than or equal to 150.

Suitable polyoxyalkylene polyether polyols for the isocyanate-reactive component (2) of the flexible foams are typically the reaction product of a suitable initiator or starter and one or more alkylene oxides. The polyoxyalkylene polyether polyols typically have less than or equal to about 85% by weight of copolymerized oxyethylene, based on 100% by weight of oxyalkylene present.

Thus, the isocyanate-reactive component (2) of the flexible foams comprises one or more polyoxyalkylene polyether polyols and is typically described in terms of their hydroxyl functionality, OH (hydroxyl) number, and the amount of copolymerized oxyethylene. Generally speaking, suitable polyoxyalkylene polyether polyols include those which contain from 2 to 8 hydroxyl groups per molecule, having an OH (hydroxyl) number of from 20 to 250, and containing less than equal to about 85% by weight of copolymerized oxyethylene, based on 100% by weight of oxyalkylene present in the polyether polyol.

As used herein, the hydroxyl number is defined as the number of milligrams of potassium hydroxide required for the complete hydrolysis of the fully phthalylated derivative prepared from 1 gram of polyol. The hydroxyl number can also be defined by the equation: OH=(56.1×1000/eq. wt.)=(56.1×1000)×(f/mol. wt.) where: OH: represents the hydroxyl number of the polyol; eq. wt.: weight per molar equivalents of contained OH groups; f: represents the nominal functionality of the polyol, i.e. the average number of active hydrogen groups on the initiator or initiator blend used in producing the polyol; and mol. wt.: represents the nominal number average molecular weight based on the measured hydroxyl number and the nominal functionality of the polyol.

Among the polyoxyalkylene polyols which can be used are the alkylene oxide adducts of a variety of suitable initiator molecules. Non-limiting examples include dihydric initiators such as ethylene glycol, diethylene glycol, triethylene glycol, propylene glycol, dipropylene glycol, tripropylene glycol, neopentyl glycol, 1,3-propanediol, 1,4-butanediol, 1,6-hexanediol, 1,4-cyclo-hexanediol, 1,4-cyclohexane-dimethanol, hydroquinone, hydroquinone bis(2-hydroxyethyl)ether, the various bisphenols, particularly bisphenol A and bisphenol F and their bis(hydroxyalkyl) ether derivatives, aniline, the various N-N-bis(hydroxyalkyl)anilines, primary alkyl amines and the various N-N-bis(hydroxyalkyl)amines; trihydric initiators such as glycerine, trimethylolpropane, trimethylolethane, the various alkanolamines such as ethanolamine, diethanolamine, triethanolamine, propanolamine, dipropanolamine, and tripropanolamine; tetrahydric initiators such as pentaerythritol, ethylene diamine, N,N, N′,N′-tetrakis[2-hydroxyalkyl]ethylenediamines, toluene diamine and N,N,N′,N′-tetrakis[hydroxyalkyl]toluene diamines; pentahydric initiators such as the various alkylglucosides, particularly a-methylglucoside; hexahydric initators such as sorbitol, mannitol, hydroxyethylglucoside, and hydroxypropyl glucoside; octahydric initiators such as sucrose; and higher functionality initiators such as various starch and partially hydrolyzed starch-based products, and methylol group-containing resins and novolak resins such as those prepared from the reaction of as aldehyde, such as formaldehyde, with a phenol, cresol, or other aromatic hydroxyl-containing compound.

Such starters or initiators are typically copolymerized with one or more alkylene oxides to form polyether polyols. Examples of such alkylene oxides include ethylene oxide, propylene oxide, butylenes oxide, styrene oxide and mixtures thereof. Mixtures of these alkylene oxides can be added simultaneously or sequentially to provide internal blocks, terminal blocks or random distribution of the alkylene oxide groups in the polyether polyol. A suitable mixture comprises ethylene oxide and propylene oxide, provided the total amount of copolymerized oxyethylene in the resultant polyether polyol is less than 85% by weight.

The most common process for polymerizing such polyols is the base catalyzed addition of the oxide monomers to the active hydrogen groups of the polyhydric initiator and subsequently to the oligomeric polyol moieties. Potassium hydroxide or sodium hydroxide are the most common basic catalyst used. Polyols produced by this process can contain significant quantities of unsaturated monols resulting from the isomerization of oxypropylene monomer to allyl alcohol under the conditions of the reaction. This monofunctional alcohol can then function as an active hydrogen site for further oxide addition.

One class of suitable polyoxyalkylene polyols are the low unsaturation (low monol) poly(oxypropylene/oxyethylene) polyols manufactured with double metal cyanide catalyst. The poly(oxypropylene/oxyethylene) low unsaturation polyols are prepared by oxyalkylating a suitably hydric initiator compound with propylene oxide and ethylene oxide in the presence of a double metal cyanide catalyst. The amount of ethylene oxide in the ethylene oxide/propylene oxide mixture may be increased during the latter stages of the polymerization to increase the primary hydroxyl content of the polyol. Alternatively, the low unsaturation polyol may be capped with ethylene oxide using non-DMC catalysts.

When the oxyalkylation is performed in the presence of double metal cyanide catalysts, it may be desirable that initiator molecules containing strongly basic groups such as primary and secondary amines be avoided. Further, when employing double metal cyanide complex catalysts, it is generally desirable to oxyalkylate an oligomer which comprises a previously oxyalkylated “monomeric” initiator molecule.

Polyol polymer dispersions represent another suitable class of polyoxyalkylene polyol compositions. Polyol polymer dispersions are dispersions of polymer solids in a polyol. Polyol polymer dispersions which are useful in the production of polyurethane foams include the “PHD” and “PIPA” polymer modified polyols as well as the “SAN” polymer polyols. Any “base polyol” known in the art can be suitable for production of polymer polyol dispersions, such as the poly(oxyalkylene) polyols described previously herein.

SAN polymer polyols are typically prepared by the in-situ polymerization of one or more vinyl monomers, such as acrylonitrile and styrene, in a polyol, such as a poly(oxyalkylene) polyol, having a minor amount of natural or induced unsaturation.

SAN polymer polyols typically have a polymer solids content within the range of from 3 to 60 wt. %, such as from 5 to 55 wt. %, based on the total weight of the SAN polymer polyol. As mentioned above, SAN polymer polyols are typically prepared by the in situ polymerization of a mixture of acrylonitrile and styrene in a polyol. When used, the ratio of styrene to acrylonitrile polymerized in-situ in the polyol is typically in the range of from about 100:0 to about 0:100 parts by weight, based on the total weight of the styrene/acrylonitrile mixture, such as from 80:20 to 0:100 parts by weight.

PHD polymer modified polyols are typically prepared by the in-situ polymerization of an isocyanate mixture with a diamine and/or hydrazine in a polyol, such as a polyether polyol. PIPA polymer modified polyols are typically prepared by the in situ polymerization of an isocyanate mixture with a glycol and/or glycol amine in a polyol.

PHD and PIPA polymer modified polyols typically have a polymer solids content within the range of from 3 to 30 wt. %, such as from 5 to 25 wt. %, based on the total weight of the PHD or PIPA polymer modified polyol. As mentioned above, PHD and PI PA polymer modified polyols are typically prepared by the in-situ polymerization of an isocyanate mixture, typically, a mixture which is composed of about 80 parts by weight, based on the total weight of the isocyanate mixture, of 2,4-toluene diisocyanate and about 20 parts by weight, based on the total weight of the isocyanate mixture, of 2,6-toluene diisocyanate, in a polyol, such as a poly(oxyalkylene) polyol.

By the term “polyoxyalkylene polyol or polyoxyalkylene polyol blend” is meant the total of all polyoxyalkylene polyether polyols, whether polyoxyalkylene polyether polyols containing no polymer dispersion or whether the base polyol(s) of one or more polymer dispersions.

It should also be appreciated that blends or mixtures of various useful polyoxyalkylene polyether polyols may be used if desired. It is possible that one of the polyether polyols has a functionality, OH number, etc. outside of the ranges identified above. In addition, the isocyanate-reactive component may comprise one or more polyoxyalkylene monols formed by addition of multiple equivalents of epoxide to low molecular weight monofunctional starters such as, for example, methanol, ethanol, phenols, allyl alcohol, longer chain alcohols, etc., and mixtures thereof. Suitable epoxides can include, for example, ethylene oxide, propylene oxide, butylene oxide, styrene oxide, etc. and mixtures thereof. The epoxides can be polymerized using well-known techniques and a variety of catalysts, including alkali metals, alkali metal hydroxides and alkoxides, double metal cyanide complexes, and many more. Suitable monofunctional starters can also be made, for example, by first producing a diol or triol and then converting all but one of the remaining hydroxyl groups to an ether, ester or other non-reactive group.

Suitable blowing agents to be used as component (3) include, for example, halogenated hydrocarbons, water, liquid carbon dioxide, low boiling solvents such as, for example, pentane, and other known blowing agents. Water may be used alone or in conjunction with other blowing agents such as, for example, pentane, acetone, cyclopentanone, cyclohexane, partially or completely fluorinated hydrocarbons, methylene chloride and liquid carbon dioxide. In some cases water is used as the sole blowing agent or water used in conjunction with liquid carbon dioxide. Generally, speaking, the quantity of blowing agent present is from 0.3 to 30 parts, such as from 0.5 to 20 parts by weight, based on 100 parts by weight of component (2) present in the formulation.

Suitable catalysts for component (4), include, for example, the various polyurethane catalysts which are known to be capable of promoting the reaction between the aromatic polyisocyanate component and the isocyanate-reactive components, including water. Examples of such catalysts include, but are not limited to, tertiary amines and metal compounds as are known and described in the art. Some examples of suitable tertiary amine catalysts include triethylamine, triethylenediamine, tributylamine, N-methylmorpholine, N-ethyl-morpholine, N,N,N′,N′-tetra-methylethylene diamine, pentamethyl-diethylene triamine, and higher homologs, 1,4-diazabicyclo[2.2.2]octane, N-methyl-N′(dimethylaminoethyl)piperazine, bis(dimethylaminoalkyl)-piperazines, N,N-dimethylbenzylamine, N,N-dimethylcyclohexylamine, N,N-diethylbenzylamine, bis(N,N-diethyl-aminoethyl)adipate, N,N,N′,N′-tetramethyl-1,3-butanediamine, N,N-dimethyl-β-phenylethylamine, 1,2-dimethylimidazole, 2-methylimidazole, monocyclic and bicyclic amidines, bis(dialkylamino)alkyl ethers (such as bis(N,N-dimethylaminoethyl)ether), and tertiary amines containing amide groups (such as formamide groups). The catalysts used may also be the known Mannich bases of secondary amines (such as dimethylamine) and aldehydes (such as formaldehyde) or ketones (such as acetone) and phenols.

Suitable catalysts also include certain tertiary amines containing isocyanate reactive hydrogen atoms. Examples of such catalysts include triethanolamine, triisopropanolamine, N-methyldiethanolamine, N-ethyl-diethanolamine, N,N-dimethylethanolamine, their reaction products with alkylene oxides (such as propylene oxide and/or ethylene oxide) and secondary-tertiary amines.

Other suitable catalysts include acid blocked amines (i.e. delayed action catalysts). The blocking agent can be an organic carboxylic acid having 1 to 20 carbon atoms, such as 1-2 carbon atoms. Examples of blocking agents include 2-ethyl-hexanoic acid and formic acid. Any stoichiometric ratio can be employed, such as one acid equivalent blocking one amine group equivalent. The tertiary amine salt of the organic carboxylic acid can be formed in situ, or it can be added to the polyol composition ingredients as a salt, such as a quaternary ammonium salt. Additional examples of suitable organic acid blocked amine gel catalysts which may be employed are the acid blocked amines of triethylene-diamine, N-ethyl or methyl morpholine, N,N dimethylamine, N-ethyl or methyl morpholine, N,N dimethylaminoethyl morpholine, N-butyl-morpholine, N,N′ dimethylpiperazine, bis(dimethylamino-alkyl)-piperazines, 1,2-dimethyl imidazole, dimethyl cyclohexylamine. Further examples include DABCO® 8154 catalyst based on 1,4-diazabicyclo[2.2.2]octane and DABCO® BL-17 catalyst based on bis(N,N-dimethylaminoethyl)ether (available from Air Products and Chemicals, Inc., Allentown, Pa.) and POLYCAT® SA-1, POLYCAT® SA-102, and POLYCAT® SA-610/50 catalysts based on POLYCAT® DBU amine catalyst (available from Air Products and Chemicals, Inc.) as are known.

Other suitable catalysts include organic metal compounds, especially organic tin, bismuth, and zinc compounds. Suitable organic tin compounds include those containing sulfur, such as dioctyl tin mercaptide, and, such as tin(II) salts of carboxylic acids, such as tin(II) acetate, tin(II) octoate, tin(II) ethylhexoate, and tin(II) laurate, as well as tin(IV) compounds, such as dibutyltin dilaurate, dibutyltin dichloride, dibutyltin diacetate, dibutytin maleate, and dioctyltin diacetate. Suitable bismuth compounds include bismuth neodecanoate, bismuth versalate, and various bismuth carboxylates. Suitable zinc compounds include zinc neodecanoate and zinc versalate. Mixed metal salts containing more than one metal (such as carboxylic acid salts containing both zinc and bismuth) are also suitable catalysts.

The quantity of catalyst varies widely depending on the specific catalyst used. Generally speaking, suitable levels of catalyst would be readily determined by those skilled in the art of polyurethane chemistry.

Suitable surfactants to be used as component (5) include silicone surfactants such as, for example, polysiloxanes and siloxane/poly(alkylene oxide) copolymers of various structures and molecular weights. The structure of these compounds is generally such that a copolymer of ethylene oxide and propylene oxide is attached to a polydimethyl siloxane radical. In some cases, such surfactants are used in amounts of from 0.05 to 5% by weight, such as 0.2 to 3% by weight (based on the weight of the weight of component (2) present in the formulation.

In addition, other additives which may be used include, for example, release agents, pigments, cell regulators, flame retarding agents, foam modifiers, plasticizers, dyes, antistatic agents, antimicrobials, cross-linking agents, antioxidants, UV stabilizers, mineral oils, fillers (such as calcium carbonate and barium sulfate) and reinforcing agents such as glass in the form of fibers or flakes or carbon fibers.

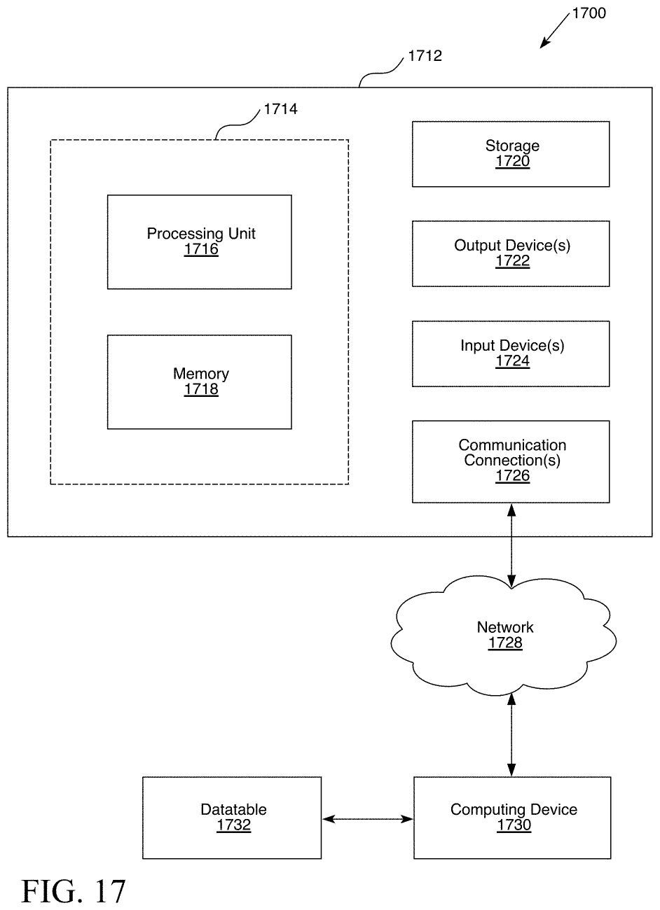

FIG. 17 illustrates an example computing environment 1700 wherein one or more of the provisions set forth herein may be implemented. FIG. 17 illustrates an example of a system 1700 comprising a computing device 1712 configured to implement one or more aspects provided herein. In one configuration, the computing device 1712 includes at least one processing unit 1716 and a memory 1718. Depending on the exact configuration and type of computing device, the memory 1718 may be volatile (such as RAM, for example), non-volatile (such as ROM, flash memory, etc., for example) or some combination of the two. This configuration is illustrated in FIG. 17 by a dashed line 1714.

In other aspects, the computing device 1712 may include additional features and/or functionality. For example, the computing device 1712 also may include additional storage (e.g., removable and/or non-removable) including, but not limited to, magnetic storage, optical storage, and the like. Such additional storage is illustrated in FIG. 17 by a storage 1720. In one aspect, computer readable instructions to implement one or more aspects provided herein may be stored in the storage 1720. The storage 1720 also may store other computer readable instructions to implement an operating system, an application program, and the like. Computer readable instructions may be loaded in the memory 1718 for execution by the processing unit 1716, for example.

The term “computer readable media” as used herein includes computer storage media. Computer storage media includes volatile and nonvolatile, removable and non-removable media implemented in any method or technology for storage of information such as computer readable instructions or other data. The memory 1718 and the storage 1720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by the computing device 1712. Computer storage media does not, however, include propagated signals. Rather, computer storage media excludes propagated signals. Any such computer storage media may be part of the computing device 1712.

The computing device 1712 also may include one or more communication connection(s) 1726 that allows the computing device 1712 to communicate with other devices such as the computing device 1730. The communication connection(s) 1726 may include, but is not limited to, a modem, a Network Interface Card (NIC), an integrated network interface, a radio frequency transmitter/receiver, an infrared port, a USB connection, or other interfaces for connecting the computing device 1712 to other computing devices. The communication connection(s) 1726 may include a wired connection or a wireless connection. The communication connection(s) 1726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

The computing device 1712 may include one or more input device(s) 1724 such as keyboard, mouse, pen, voice input device, touch input device, infrared cameras, video input devices, and/or any other input device. Output input device(s) 1722 such as one or more displays, speakers, printers, and/or any other output device may also be included in the computing device 1712. The one or more input device(s) 1724 and one or more output device(s) 1722 may be connected to the computing device 1712 via a wired connection, wireless connection, or any combination thereof. In one aspect, an input device or an output device from another computing device may be used as the input device(s) 1724 or the output device(s) 1722 for the computing device 1712.

Components of the computing device 1712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another aspect, components of the computing device 1712 may be interconnected by a network. For example, the memory 1718 may be comprised of multiple physical memory units located in different physical locations interconnected by a network.

Storage devices utilized to store computer readable instructions may be distributed across a network. For example, a computing device 1730 accessible via a network 1728 may store computer readable instructions to implement one or more aspects provided herein. The computing device 1712 may access the computing device 1730 and download a part or all of the computer readable instructions for execution. Alternatively, computing device 1712 may download pieces of the computer readable instructions, as needed, or some instructions may be executed at the computing device 1712 and some at the computing device 1730. The computing device 1730 may be coupled to a stored data table 1732. The contents of the data table 1732 can be accessed by both computing devices 1712, 1730. In one aspect, the data table 1732 stores the formulation data set that is used to generate the ternary plots and the square plots described herein. The data table 1732 may be employed to store the data tables described herein.

The computing device 1730 may include all or some of the components of the computing device 1712. For example, in one aspect the computing device 1730 includes at least one processing unit and a memory, e.g., a volatile memory (such as RAM, for example), a non-volatile memory (such as ROM, flash memory, etc., for example) or some combination of the two. In other aspects, the computing device 1730 may include additional storage (e.g., removable and/or non-removable) including, but not limited to, magnetic storage, optical storage, and the like. In one aspect, computer readable instructions to implement one or more aspects provided herein may be stored in the storage. The storage also may store other computer readable instructions to implement an operating system, an application program, and the like. Computer readable instructions may be loaded in the memory for execution by the processing unit, for example.

The computing device 1730 also may include one or more communication connection(s) that allows the computing device 1730 to communicate with other devices such as the computing device 1712. The communication connection(s) may include, but is not limited to, a modem, a Network Interface Card (NIC), an integrated network interface, a radio frequency transmitter/receiver, an infrared port, a USB connection, or other interfaces for connecting the computing device 1730 to other computing devices. The communication connection(s) may include a wired connection or a wireless connection. The communication connection(s) may transmit and/or receive communication media.

The computing device 1730 may include one or more input device(s) such as keyboard, mouse, pen, voice input device, touch input device, infrared cameras, video input devices, and/or any other input device. Output input device(s) such as one or more displays, speakers, printers, and/or any other output device may also be included in the computing device 1730. The one or more input device(s) and one or more output device(s) may be connected to the computing device via a wired connection, wireless connection, or any combination thereof. In one aspect, an input device or an output device from another computing device may be used as the input device(s) or the output device(s) for the computing device 1730.

Components of the computing device 1730 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another aspect, components of the computing device 1730 may be interconnected by a network. For example, the memory may be comprised of multiple physical memory units located in different physical locations interconnected by a network.

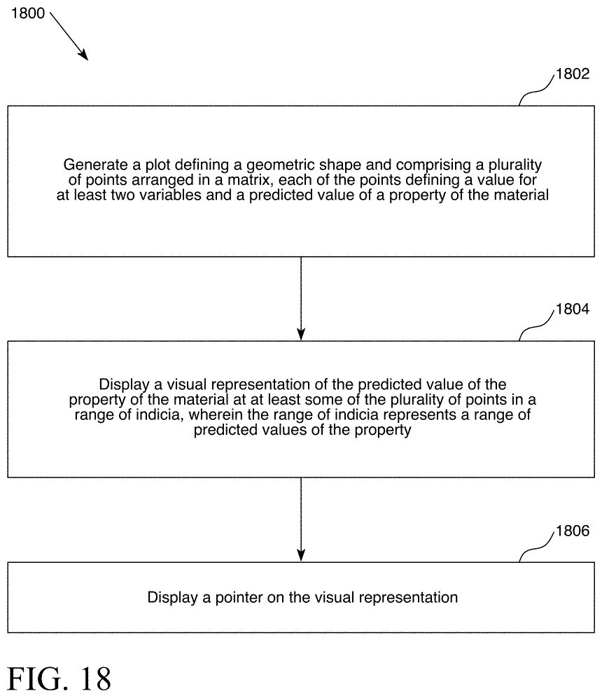

FIG. 18 is a logic flow diagram of a logic configuration or process 1800 of a method of producing a graphical depiction of a predicted value of a property of a material according to one aspect of this disclosure. The process 1800 may be executed in the computing environment 1700 described in connection with FIG. 17 based on executable instructions stored in the memory 1718 or the storage 1720. Input from the user is received by the processing unit 1716 from the input device(s) 1724. The computing device 1712 may be a client computer in communication with the computing device 1730 which may be a server coupled to a data table 1732 containing a dataset to a visual representation of the dataset. As previously discussed, the dataset may be generated by a variety of techniques, including, without limitation, design of experiments, regression analysis of a data set, an equation, machine learning, or artificial intelligence, and/or any combination thereof. In one aspect, a model may be used to generate the predicted values of the properties for a visual representation generated from a design of experiment technique. In other aspects, models for generating predictive values of properties include a statistical analysis of unstructured data, such as that generated by a historian of a distributive control system of a chemical manufacturing plant.

According to the process 1800, the processing unit 1716 generates 1802 a plot defining a geometric shape and comprising a plurality of points arranged in a matrix, each of the points defining a value for at least two variables and a predicted value of a property of the material. At least one of the at least two variables may be an independent variable and the other variables may be dependent variables. In one aspect, the processing unit 1716 may be configured to generate a predicted value of a property of a material that includes, without limitation, a foam, a coating, an adhesive, a sealant, an elastomer, a sheet, a film, a binder, or any organic polymer. In one aspect, the processing unit 1716 may be configured to generate a model for generating the plot. In one aspect, the processing unit 1716 generates the model based on design of experiments, regression analysis of a data set, an equation, machine learning, or artificial intelligence, and/or any combination thereof.

In one aspect, the processing unit 1716 may be configured to generate a geometric shape in the form of a closed shape in Euclidian space, either in a two-dimensional space or a two-dimensional perspective projection of a three-dimensional shape. The closed shape may define a polygon such as, for example, a triangle, a four-sided polygon, among other polygons, or an ellipse, a circle, among other single sided enclosed shapes. The triangle and each of the points may, for example, define a value for three variables, where each variable is a value for an amount of a component a composition. The amounts may be expressed as a percentage and a sum of the amounts is 100%. The four-sided polygon and each of the points may, for example, define a value for two variables, where each variable is a value for an amount of a component in a composition, a processing condition, or a value representing an amount of two components of the composition relative to each other.

According to the process 1800, the processing unit 1716 displays 1804, on the output device 1722, a visual representation of the predicted value of the property of the material at each of the plurality of points in a range of indicia, wherein the range of indicia represents a range of predicted values of the property. In various aspects, the visual representation may be a heat map, a color heat map, or a contour map, and/or combinations thereof.

The processing unit 1716 may be configured to display, on the output device 1722, the value of the indicia and property of the material based on a position of a cursor on the visual representation. The processing unit 1716 further may be configured to dynamically update the location of the pointer and an element as the pointer is dragged over the visual representation. The element may be displayed in the form of a numeric value or a descriptor of the property. The element may be displayed in the form of indicia within the range of indicia that represents the predicted value or the descriptor of the property in the visual representation.

According to the process 1800, the processing unit 1716 displays 1806, on the output device 1722, a pointer on the visual representation. In one aspect, the processing unit 1716 may be configured to update a table with current values of the at least two variables and the predicted value of the property based on the location of the pointer on the visual representation. In one aspect, the processing unit 1716 may be configured to generate a set of instructions for producing a product that exhibits the predicted value of the property of the material at one of the plurality of points in the range of indicia.

In one aspect, the processing unit 1716 may be configured to formulate a composition based on the visual representation of the predicted value of the property of the material for at least some of the plurality of points in the range of indicia. In one aspect, the composition may be formulated based on a plurality of properties for at least some of the plurality of points in the range of indicia. In one aspect, the processing unit 1716 may be configured to optimize one or more than one property of the material within one or more than one defined range of indicia. The processing unit 1716 may be configured to display on the output device a gridded region to represent one or more than one optimized region based on the one or more than one defined range of indicia.

In one aspect, the processing unit 1716 may be configured to generate a plurality of plots each defining a geometric shape and each comprising a plurality of points arranged in a matrix, each of the points defining a value for at least two variables and a predicted value of the property of the material for each of the plurality of plots and to display, on the output device 1722, a visual representation of the predicted value of the property of the material for at least some of the plurality of points in a range of indicia, where the range of indicia represents a range of predicted values of the property and to display, on the output device 1722, a pointer on each of the plurality of plots.

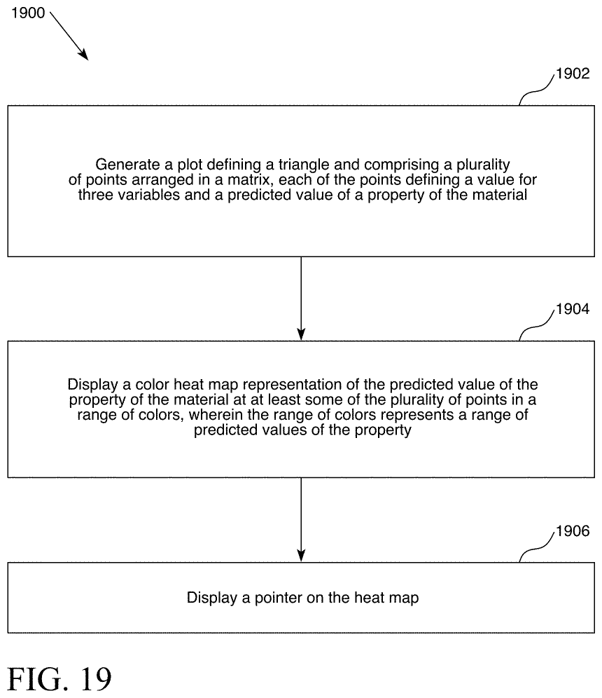

FIG. 19 is a logic flow diagram of a logic configuration or process 1900 of a method of producing a graphical depiction of a predicted value of a property of a material according to one aspect of this disclosure. The process 1900 may be executed in the computing environment 1700 described in connection with FIG. 17 based on executable instructions stored in the memory 1718 or the storage 1720. Input from the user is received by the processing unit 1716 from the input device(s) 1724. The computing device 1712 may be a client computer in communication with the computing device 1730 which may be a server coupled to a data table 1732 containing a dataset to a visual representation of the dataset.

As previously discussed, the dataset may be generated by a variety of techniques, including, without limitation, design of experiments, regression analysis of a data set, an equation, machine learning, or artificial intelligence, and/or any combination thereof. In one aspect, a model may be used to generate the predicted values of the properties for a visual representation generated from a design of experiment technique. In other aspects, models for generating predictive values of properties include a statistical analysis of unstructured data, such as that generated by a historian of a distributive control system of a chemical manufacturing plant.

According to the process 1900, the processing unit 1716 generates 1902 a plot defining a triangle and comprising a plurality of points arranged in a matrix, each of the points defining a value for three variables and a predicted value of a property of the material. At least one of the three variables is an independent variable and the other variables are dependent variables. Each of the points of the triangle defines a value for the three variables, where each of the three variables is a value representing a relative amount of components in a composition to each other. The amounts may be expressed as a percentage and a sum of the amounts is 100%. In one aspect, the processing unit 1716 is configured to generate a predicted value of a property of a material, where the material is, without limitation, a coating, an adhesive, a sealant, an elastomer, a sheet, a film, a binder, or any organic polymer. In one aspect, the processing unit 1716 is configured to generate a model for generating the plot. The model may be generated based design of experiments, regression analysis of a data set, an equation, machine learning, or artificial intelligence, and/or any combination thereof.

Examples of a plot defining a triangle include the ternary plot 210, 310, 410, 810, 910, and 1010 described in connection with the ternary map GUIs 200, 300, 400, 800, 900 and 1000. According to the process 1900, the processing unit 1716 displays 1904, on the output device 1722, a color heat map representation of the predicted value of the property of the material for at least some of the plurality of points in a range of colors, wherein the range of colors represents a range of predicted values of the property. Examples of color heat maps include the ternary heat maps 216, 316, 416, 816, 916, and 1016 described in connection with ternary map GUIs 200, 300, 400, 800, 900 and 1000.

In one aspect, the processing unit 1716 is configured to display, on the output device 1722, the variables and predicted property of the material based on a position of a cursor on the heat maps 216, 316, 416, 816, 916, and 1016. In one aspect, the processing unit 1716 is configured to dynamically update the location of a pointer and an element as the pointer is dragged over the heat map. The element may be displayed in the form of a numeric value or a descriptor of the property. The element may be displayed in the form of a color within the range of colors that represents the predicted value of the property in the heat map.

According to the process 1900, the processing unit 1716 displays 1906, on the output device 1722, a point on the heat maps 216, 316, 416, 816, 916, and 1016. An example of a pointer includes the point 212, 312, 412, 812, 912, and 1012 described in connection with the heat maps 216, 316, 416, 816, 916, and 1016. In one aspect, the processing unit 1716 may be configured to update a table with current values of the three variables and the predicted value of the property based on a location of the pointer on the heat map. The processing unit 1716 may be configured to generate a set of instructions for producing a product that exhibits the predicted value of the property of the material at one of the plurality of points in the range of colors.

In one aspect, the processing unit 1716 may be configured to formulate a composition based on the color heat map representation of the predicted value of the property of the material for at least some of the plurality of points in the range of colors. The processing unit 1716 may be configured to optimize one or more than one property of the material within one or more than one defined range of colors. The processing unit 1716 may be configured to display, on the output device 1722, a gridded region that represents one or more than one optimized region based on the one or more than one defined range of colors.

In one aspect, the processing unit 1716 is configured to generate a plurality of plots each defining a triangle shape and each comprising a plurality of points arranged in a matrix, each of the points defining a value for at least two variables and a predicted value of the property of the material for each of the plurality of plots; display, on the output device 1722, a visual representation of the predicted value of the property of the material for at least some of the plurality of points in a range of colors, where the range of colors represents a range of predicted values of the property; and display a pointer on each of the plurality of plots.

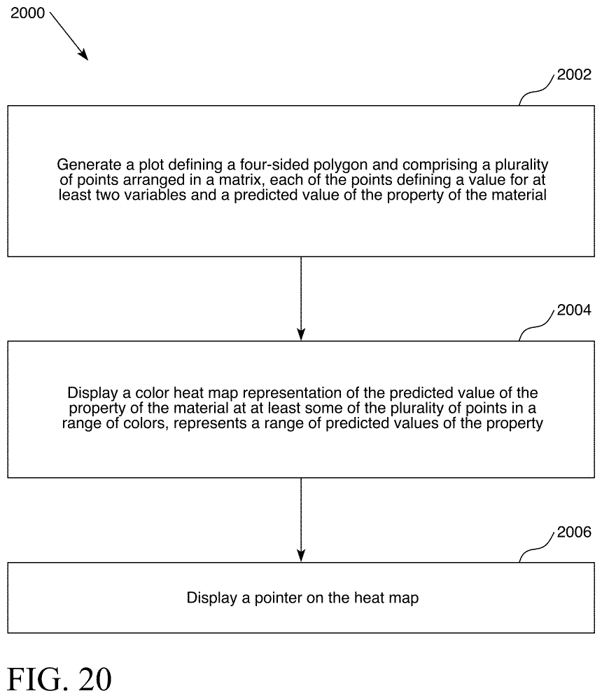

FIG. 20 is a logic flow diagram of a logic configuration or process 2000 of a method of producing a graphical depiction of a predicted value of a property of a material according to one aspect of this disclosure. The process 2000 may be executed in the computing environment 1700 described in connection with FIG. 17 based on executable instructions stored in the memory 1718 or the storage 1720. Input from the user is received by the processing unit 1716 from the input device(s) 1724. The computing device 1712 may be a client computer in communication with the computing device 1730 which may be a server coupled to a data table 1732 containing a dataset to a visual representation of the dataset.

As previously discussed, the dataset may be generated by a variety of techniques, including, without limitation, design of experiments, regression analysis of a data set, an equation, machine learning, or artificial intelligence, and/or any combination thereof. In one aspect, a model may be used to generate the predicted values of the properties for a visual representation generated from a design of experiment technique. In other aspects, models for generating predictive values of properties include a statistical analysis of unstructured data, such as that generated by a historian of a distributive control system of a chemical manufacturing plant.

According to the process 2000, the processing unit 1716 generates 2002 a plot defining a four-sided polygon and comprising a plurality of points arranged in a matrix, each of the points defining a value for at least two variables and a predicted value of the property of the material. At least one of the two variables is an independent variable and the other variable is a dependent variable. At least two variables is a value for an amount of a component in a composition, a processing condition, or a value representing an amount of two components of the composition relative to each other. In one aspect, the processing unit 1716 is configured to generate a predicted value of a property of a material, such as a flexible polyurethane foam. In one aspect, the processing unto 1716 is configured to generate a model for generating the plot. The model may be generated based design of experiments, regression analysis of a data set, an equation, machine learning, or artificial intelligence, and/or any combination thereof.

In some aspects, a digital formulation service is provided for generating optimized material configurations, both in types of materials and cost. A computerized system may be configured to provide a digital formulation service module that allows a user to generate a custom material configuration based on a specified constraint, such as cost or performance. The digital formulation service may provide a recommended material configuration that satisfies the specified constraint. The digital formulation service module may be an augmented or supplemental service with the other user interfaces described herein, such as those described in FIGS. 1-20. For example, after developing a custom coating using the gauge interfaces described in FIGS. 1-16, the digital formulation service may be configured to transmit the custom formulation to one or more entities that facilitate supplying the materials and sending the materials to the customer. Examples of these models for completing the customer order will be described more, below.

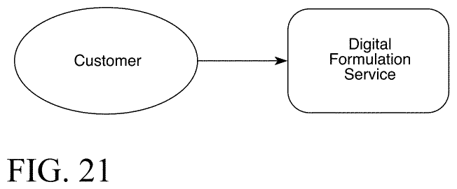

FIG. 21 shows a basic block diagram of a user or customer interfacing with the digital formulation service, which may be manifested in a computerized module. In this context, the digital formulation service may provide custom material configurations in a wide variety of ways. In some aspects, the digital formulation service is configured to generate a material configuration by optimizing based on cost of the ingredients to make the material. For example, to generate a custom coating, the customer may specify to the digital formulation service module to provide a recommended coating recipe that gives the best performance at a specified cost, or in other cases, at the lowest cost. In some aspects, the service module may provide the recommended recipe at the specified cost using default ingredients, since no other constraints may be specified.

In some aspects, the digital formulation service module may be configured to generate a material configuration, such as a custom coating, by optimizing formulation based on performance. In this example, the user may specify one or more criteria that one or more of the particular qualities of a coating must satisfy. For example, the user may specify that the custom coating must possess at least a minimum amount of smoothness, or must resist DEET at a particular minimum level. The digital formulation service module is then configured to analyze all known recipes, in some cases using just default ingredients, satisfying the performance constraint(s). The module then may provide a recommendation at the least expensive cost. The known recipes may be based on empirical research and tabulation that are stored in a database.

In some aspects, the digital formulation service module may also be configured to provide optimization configurations using substitute ingredients. For example, if a user instructs the service module to generate a custom coating by optimizing the formulation based on performance, the user may also specify to analyze all known recipes to satisfy the performance constraint using default ingredients as well as all permutations of substitute ingredients. The substitute ingredients may be based on empirical research and knowledge of physical properties that are stored in a database.

In other cases, the customer may simply supply to the digital formulation service the specifications for performance with the full recipe and workup information for how to generate the desired custom coating. From here, the digital formulation service may determine the most efficient or effective method for obtaining the materials. For example, the ingredients may come from one or more sources, and it may not be relevant to the customer what the sources are, so long as the proper ingredients are obtained. Alternatively, the digital formulation service may allow for the customer to specify the sources for obtaining the ingredients.

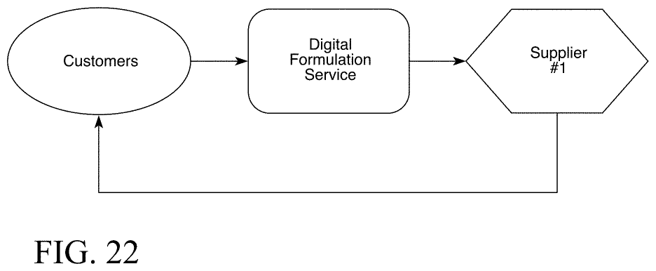

Referring to FIG. 22, shown is one model for how the digital formulation service may complete a custom coating order, according to some aspects. In the case where the customer specifies the coating performance by supplying the particular desired recipe, the digital formulation service may instruct a supplier to obtain the specific ingredients for the recipe. The digital formulation service may be able to access current inventory information from the supplier in order to determine if the order can be immediately fulfilled or if more efforts need to be taken to obtain particular ingredients. Ultimately, the supplier may be sent the customer shipping information and may send the raw materials (ingredients) to the customer.

In another scenario, in the case where the customer may specify the performance of a coating but where the recipe information for the exact type of materials or ingredients is not specified, the digital formulation service may complete the order by performing optimization calculations to determine the best types of materials that satisfy the performance constraints. The gauge interfaces described in FIGS. 1-16 may be one example of how the performance constraints may be specified and then the types of materials may be determined thereafter. The digital formulation service may pass on a recipe based on this to the supplier. The supplier may then fulfill the order and send to the customer the raw materials and/or blends to the customer. The supplier may also send full coating systems to the customer, based on the received recipe from the digital formulation service.

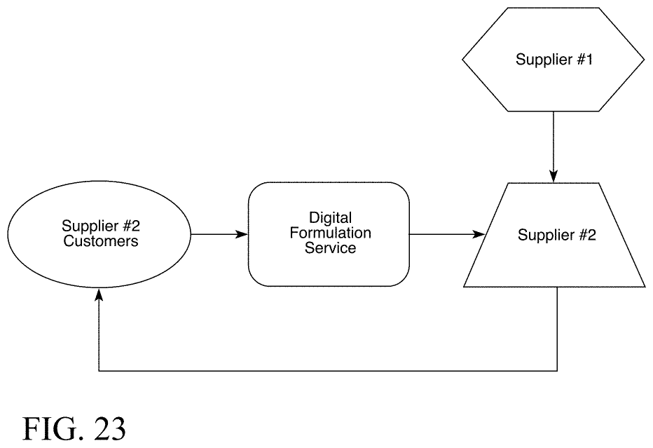

Referring to FIG. 23, shown is a second model in a variation of how the digital formulation service may complete a custom coating order, according to some aspects. In this example, customers of a second supplier may also use the digital formulation service, and may expect to receive orders fulfilled by the second supplier (supplier #2), such as a system house. The digital formulation service may be controlled by the first supplier (supplier #1), but may be utilized by the second supplier. The first supplier may supply the raw materials to the second supplier so that the second supplier can complete the order to their customers, as their customers expect. Thus, the second supplier may send the custom raw materials and/or blends to the customer. The second supplier may also supply full coating systems to the customer. This type of model enables the digital formulation service to be utilized by other entities that do not control or own the digital formulation service, so that more customers can still have access to the digital formulation service's capabilities.

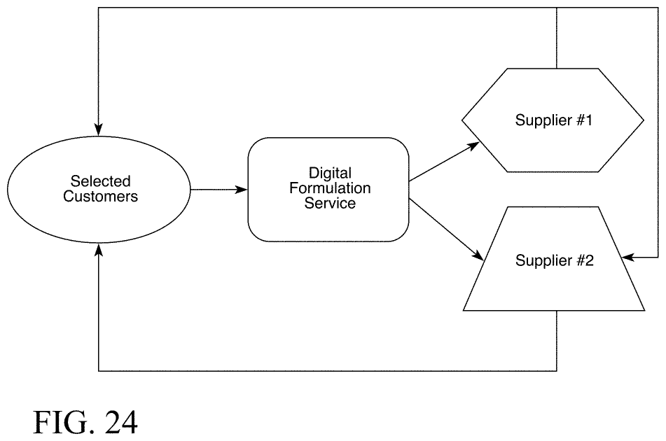

Referring to FIG. 24, shown is another model in another variation of how the digital formulation service may complete a custom coating order, according to some aspects. In this example, the digital formulation service may act as a neutral or hybrid platform that can send orders to different suppliers, depending on the need. For example, the digital formulation service may send custom coating recipes for high volume orders to the first supplier, while low volume orders may be sent to the second supplier. This may be most efficient because the first supplier may be larger and have more capacity to handle large orders, while the second supplier may be more specialized and/or have the supplies to handle smaller or more individualized orders. In some aspects, the second supplier may still lack certain materials or ingredients to fulfill even the small orders, and the first supplier may be configured to send the missing supplies to the second supplier to complete the order. Once the orders can be fulfilled, the first supplier may send the raw materials to the customer, and similarly the second supplier may also send the raw materials and/or blends to the customer. Full coatings systems may also be supplied to the customer by the second or first supplier.

In some aspects, in another variation of the neutral or hybrid platform, the digital formulation service may be configured to send orders to either the first or second supplier based on a competitive bidding process undertaken by the first and second (and possibly additional) suppliers. The bidding system may be setup as an automatic bidding system, where analysts from the different suppliers may input automatic bidding rules for various types of recipes or materials. The bidding process may be resolved automatically as part of the process to complete the customer order. In other cases, the bidding process may be conducted more manually, and the digital formulation service may be configured to provide the forum to conduct this process. The winning bid may be the bid that offers to fulfill the order at the lowest cost to the customer.

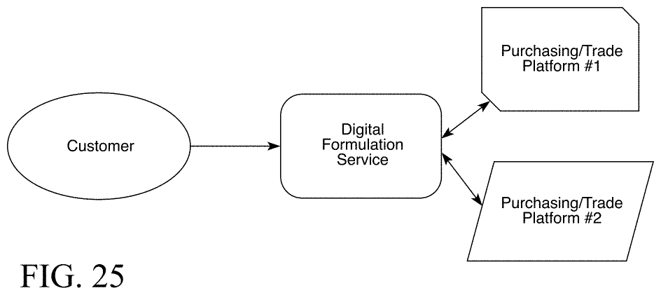

Referring to FIG. 25, in another variation, after generating a recommended material configuration satisfying user specified constraint(s), the digital formulation service module may be configured to interface with one or more purchasing/trade platforms that supply the ingredients needed to generate the recommended formulation, according to some aspects. The digital formulation service module may conduct a comparison of prices for the ingredients offered by the purchasing/trade platforms, either individually or collectively, in order to obtain the lowest price for the customer. This function may be applied to both small and large volume purchases, but the process for conducting these purchases may differ. For example, the digital formulation service module may be configured to analyze different vendors that offer large volume purchases, or may initiate negotiations with a purchase/trade platform to obtain better prices for large volume purchases. In addition, customers who specify looking for large volume purchases may be offered advanced options for finding the best prices, such as examining sales, coupons, and specialized discounts based on the customer's status or other known advantages.

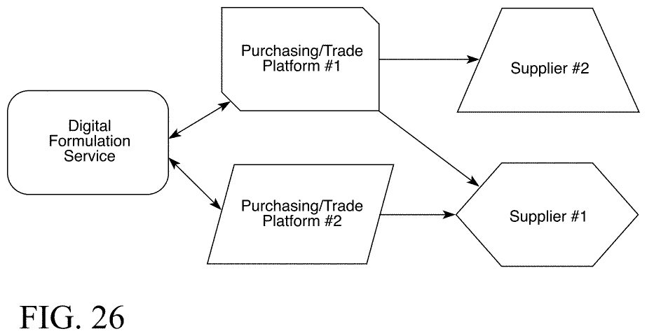

Referring to FIG. 26, in some aspects, the purchase mechanisms can be extended to include convenient and more streamlined features that can automatically connect to appropriate suppliers. After determining pricing, and depending on the purchasing/trade platform that will be used to purchase from for the desired order, one or more suppliers may be chosen from to fulfill the order. In some aspects, a purchasing/trade platform may be in contact with more than one supplier, such as Supplier #1 and Supplier #2 as shown, in order to handle different sizes of orders or address orders that have unique types of ingredients or parts. In some aspects, the digital formulation service may allow for a “touchless” order where there is a default purchasing platform and supplier used to fulfill orders by default.

Various operations of aspects are provided herein. In one aspect, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each aspect provided herein. Also, it will be understood that not all operations are necessary in some aspects.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

Various aspects of the subject matter described herein are set out in the following numbered examples:

Example 1. A method of producing a graphical depiction of a predicted value of a property of a material. T method comprises generating, by a processing unit, a plot defining a geometric shape and comprising a plurality of points arranged in a matrix, each of the points defining a value for at least two variables and a predicted value of a property of the material; generating, by a processing unit, an illustration defining a geometric shape and comprising a dynamically changing predicted characteristic, wherein the dynamically changing characteristic comprises a predicted value of a property of the material; displaying, on an output device, a visual representation of the predicted value of the property of the material for at least some of the plurality of points in a range of indicia, wherein the range of indicia represents a range of predicted values of the property; displaying, on the output device, a point on the visual representation, wherein the visual representation comprises a spider-plot illustrating the values associated with the point with regard to the axis of the geometric shape; and wherein dynamically moving the point on the visual representation dynamically changes the predicted characteristic depicted on the illustration.

Example 2. The method of Example 1, wherein the geometric shape comprises a ternary plot.

Example 3. The method of any one of Examples 1-2, wherein the illustration comprises a gauge.

Example 4. The method of Example 3, wherein the gauge comprises a dynamically changing illustration, wherein the dynamically changing illustration changes with respect to a change in the predicted property of the material.

Example 5. The method of any one of Examples 1-4, further comprising dynamically updating the location of the point as a pointer is dragged over the visual representation.

Example 6. The method of Example 5, wherein dynamically updating the location of the point dynamically changes the predicted property depicted on the illustration and the dynamically changing illustration with respect to the predicted property of the material.

Example 7. The method of any one of Examples 1-4, wherein the visual representation is a heat map, a color heat map, or a contour map.

Example 8. The method of any one of Examples 1-7, further comprising generating a recipe for producing the material that satisfies the valid ranges of each of the properties.

Example 9. The method of Example 8, further comprising transmitting the recipe to one or more suppliers to obtain ingredients sufficient to produce the material and satisfy the valid ranges of each of the properties.

Example 10. The method of Example 9, wherein transmitting the recipe to the one or more suppliers is based on determining a supplier that can obtain the ingredients at the lowest total cost.

Example 11. The method of Examples 9 or 10, wherein transmitting the recipe to the one or more suppliers is based on conducting a competitive bidding process between two or more suppliers.

Example 12. The method of Examples 9-11, wherein transmitting the recipe to the one or more suppliers is based on determining which suppliers are capable of obtaining the ingredients sufficient to fulfill the recipe.

1. A method of producing a graphical depiction of a predicted value of a property of a material, the method comprising:
generating, by a processing unit, a plot defining a geometric shape and comprising a plurality of points arranged in a matrix, each of the points defining a value for at least two variables and a predicted value of a property of the material;
generating, by a processing unit, an illustration defining a geometric shape and comprising a dynamically changing predicted characteristic, wherein the dynamically changing characteristic comprises a predicted value of a property of the material;
displaying, on an output device, a visual representation of the predicted value of the property of the material for at least some of the plurality of points in a range of indicia, wherein the range of indicia represents a range of predicted values of the property;
displaying, on the output device, a point on the visual representation, wherein the visual representation comprises a spider-plot illustrating the values associated with the point with regard to the axis of the geometric shape; and
wherein dynamically moving the point on the visual representation dynamically changes the predicted characteristic depicted on the illustration.

2. The method of claim 1, wherein the geometric shape comprises a ternary plot.

3. The method of claim 1, wherein the illustration comprises a gauge.

4. The method of claim 3, wherein the gauge comprises a dynamically changing illustration, wherein the dynamically changing illustration changes with respect to a change in the predicted property of the material.

5. The method of claim 1, further comprising dynamically updating the location of the point as a pointer is dragged over the visual representation.

6. The method of claim 5, wherein dynamically updating the location of the point dynamically changes the predicted property depicted on the illustration and the dynamically changing illustration with respect to the predicted property of the material.

7. The method of claim 1, wherein the visual representation is a heat map, a color heat map, or a contour map.

8. The method of claim 1, further comprising:
generating a recipe for producing the material that satisfies the valid ranges of each of the properties

9. The method of claim 8, further comprising:
transmitting the recipe to one or more suppliers to obtain ingredients sufficient to produce the material and satisfy the valid ranges of each of the properties.

10. The method of claim 9, wherein transmitting the recipe to the one or more suppliers is based on determining a supplier that can obtain the ingredients at the lowest total cost.

11. The method of claim 9, wherein transmitting the recipe to the one or more suppliers is based on conducting a competitive bidding process between two or more suppliers.

12. The method of claim 9, wherein transmitting the recipe to the one or more suppliers is based on determining which suppliers are capable of obtaining the ingredients sufficient to fulfill the recipe.
